(19) United States
(12) Patent Application Publication
(10) Pub. No.: US 2026/0238555 A1
(43) Pub. Date: Aug. 13, 2026

(54) METHOD, USER EQUIPMENT, AND ACCESS NETWORK NODE

(71) Applicant: NEC Corporation, Tokyo (JP)

(72) Inventors: Pravjyot DEOGUN, Milton Keynes (GB); Xuelong WANG, Guildford (GB); Neeraj GUPTA, London (GB)

(73) Assignee: NEC Corporation, Tokyo (JP)

(21) Appl. No.: 19/154,842

(22) PCT Filed: Feb. 6, 2024
(86) PCT No.: PCT/JP2024/003904

§ 371 Date: Aug. 8, 2025

(30) Foreign Application Priority Data
Feb. 16, 2023 (GB) 2302236.1

(51) Int. Cl. H04L 41/16

(52) U.S. Cl. CPC H04L 41/16

(57) ABSTRACT

The present disclosure relates to a method performed by an access network node, the method comprising: transmitting, to a user equipment, UE, an indication of a feature for implementation in a cell of the access network node, wherein the feature is implemented using a corresponding model for generating a determination, prediction, or output parameter; receiving, from the UE, a request for the model; and transmitting, to the UE, at least one of: model transmission information that includes an indication of one or more communication resources for use by the UE to receive the model; or the model.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to artificial intelligence and machine learning (AI/ML) models used in ‘New Radio’ systems (also referred to as ‘Next Generation’ systems), and similar systems.

### BACKGROUND ART

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term (R)AN node, base station, or access network node to refer to any such access nodes.

Some of the additional developments in 3GPP relate to the use of artificial intelligence (AI) and machine learning (ML), often abbreviated to AI/ML. Predictions or inferences generated using an AI/ML model can be used as part of various methods for improving the reliability or efficiency of communications in the network. For example, AI/ML models can be used to predict the path of a UE based on previous mobility of the UE, used for beam management, or used in methods of encoding and transmitting information. An AI/ML model may be hosted at a base station, and the base station may perform control of communication resources or control related to the status of a UE (e.g. control of UE mobility, or control of a radio resource control, RRC, state of the UE) based on an inference (e.g. determination or prediction) generated using the AI/ML model. The base station may also transmit an inference generated using the model to another node in the network, for use at the other node. Alternatively, an AI/ML model may be hosted at two nodes of the network, for example at a base station and at a UE. In this case, the base station and the UE may both make determinations or predictions using the model. For example, the UE may use the model as part of an encoding process for encoding (and/or compressing) channel state information (CSI) for transmission to the base station, and the base station may use the same model as part of a corresponding decoding (and/or decompression) process for decoding the CSI received from the UE.

### CITATION LIST

### Non Patent Literature

NPL 1: NGMN Alliance, “5G White Paper” (https://www.ngmn.org/5g-white-paper.html)

### SUMMARY OF INVENTION

### Technical Problem

Improved methods for propagating AI/ML models and associated information between the nodes of the communication network are needed. For example, a relatively large amount of data may be needed to transfer the AI/ML model, and more efficient and reliable methods for transferring AI/ML models are needed. Moreover, an AI/ML model for deployment at a UE might not be stored at the base station that communicates with the UE, and could be stored at an external server. Efficient and reliable mechanisms for transferring the AI/ML model from the server to the node that is to use the model are needed.

There is also a problem that the transfer of an AI/ML model to a network node may be interrupted, for example due to radio link failure between a UE and a base station. Methods for mitigating against such interruptions are needed. For example, improved methods are needed for when a transfer of an AI/ML model from a base station to a UE is interrupted due to radio link failure, but the AI/ML model is no longer available at the base station after the radio link has been restored.

In some implementations, a base station may need to determine which models are in use by UEs in a cell of the base station. For example, for so-called ‘two-sided’ models in which the UE and the base station generate a joint inference (e.g. for encoding and decoding) using a model provided at the UE and a corresponding model provided at the base station, synchronisation between the model version at the UE and the model version at the base station may be needed. Improved methods for monitoring and controlling the AI/ML models used at the UE are needed.

There is also a problem that a UE may determine to obtain and run an AI/ML model, or may be instructed to obtain and run an AI/ML model by the network, but in some scenarios the UE may not have sufficient memory or processing resources to store or run the model.

More generally, there is a need for improved methods for enabling more efficient and reliable transmission and of AI/ML models between nodes in the communication network, and control of the use of the AI/ML model by entities in the network.

The disclosure aims to provide apparatus and methods that at least partially address the above needs and/or issues.

### Solution to Problem

In a first aspect the inventio provides a method performed by an access network node, the method comprising: transmitting, to a user equipment, UE, an indication of a feature for implementation in a cell of the access network node, wherein the feature is implemented using a corresponding model for generating a determination, prediction, or output parameter; receiving, from the UE, a request for the model; and transmitting, to the UE, at least one of: model transmission information that includes an indication of one or more communication resources for use by the UE to receive the model; or the model.

The model may be an artificial intelligence or machine learning, AI/ML, model. The indication of the feature may be transmitted by the access network node in system information.

The method may further comprise transmitting, to the UE, information indicating one or more communication resources for use by the UE to request model information corresponding to the model; receiving the request for the model information from the UE; and transmitting the model information to the UE.

The model information may comprise at least one of an indication of the identity of the model or a version number of the model.

The method may further comprise receiving, from the UE, information indicating a characteristic of the UE; and determining, based on the characteristic of the UE, at least one of: the model to transmit to the UE, or a configuration for the model to be transmitted to the UE.

The characteristic of the UE may comprise at least one of a capability of the UE, a type of the UE, an indication of a model supported by the UE, or an indication of a configuration for the model supported by the UE.

The method may further comprise transmitting, to the UE, at least one of: an indication of the model to be transmitted to the UE, an indication of the configuration for the model to be transmitted to the UE, or a size of the model. The configuration for the model may comprise one or more parameters for use with the model to generate the determination, prediction or output parameter.

The method may further comprise transmitting the model to the UE using the indicated communication resources.

The indicated communication resources may be for use by the UE to receive the model from a node other than the access network node.

The node other than the access network node may be a server that stores the model, or a core network node.

The indicated communication resources may comprise at least one of a network address of the node other than the access network node, or a configuration for a radio bearer for receiving the model from the node other than the access network node.

The request for the model may comprise an indication of the identity of the model requested by the UE.

The one or more communication resources for use by the UE to receive the model may comprise at least one of a time or frequency resource for use by the UE to receive the model.

The one or more communication resources for use by the UE to receive the model may comprise an indication that the model is to be transmitted to the UE after a predetermined time period has elapsed.

In a case where the access network node transmits the model to the UE, the access network node may transmit the model to a plurality of UEs, including the UE, in a broadcast or multicast transmission.

In a case where the access network node transmits the model to the UE, the method may further comprise receiving, from the UE, an indication of whether the model has been received at the UE.

The method may further comprise determining whether the model has been received at the UE based on the indication of whether the model has been received at the UE; and retransmitting the model to the UE in a case where the access network node determines that the model has not been received at the UE.

The method may comprise: receiving the request for the model in a radio resource control, RRC, transmission; and transmitting the model to the UE using an RRC transmission.

The model may be an AI/ML model, and the method may comprise at least one of: receiving the request for the model using a dedicated protocol layer for transmission of information related to AI/ML models; or transmitting the model to the UE using the dedicated protocol layer.

The model may be an AI/ML model, and the method may comprise: receiving the request for the model in an RRC transmission; and transmitting the model to the UE using a dedicated protocol layer for transmission of information related to AI/ML models.

The model may be an AI/ML model, and the method may comprise receiving the request for the model in an RRC transmission; wherein the indication of one or more communication resources for use by the UE to receive the model includes an indication that the UE is to receive the model using an application layer protocol.

The indication of one or more communication resources for use by the UE to receive the model may include a transport address for the application layer.

The model may be an AI/ML model, and the indication of one or more communication resources for use by the UE to receive the model may include an indication that the UE is to receive the model using a dedicated protocol stack for transmission of information related to AI/ML models.

In another aspect the disclosure provides a method performed by an access network node, the method comprising: receiving, from a user equipment, UE, UE capability information that indicates at least one of: a feature supported by the UE, wherein the feature is implemented using a corresponding model for generating a determination, prediction or output parameter, a model for generating a determination, prediction or output parameter that is supported by the UE, or an indication of one or models stored at the UE; determining, based on the UE capability information, a model to be transmitted to, or activated at, the UE; and transmitting, to the UE, at least one of: model transmission information that includes an indication of one or more communication resources for use by the UE to receive the model; the model; or a request for the UE to activate the model.

The model may be an artificial intelligence or machine learning, AI/ML, model. The method may further comprise: determining, based on the UE capability information, to request further UE capability information from the UE; transmitting, to the UE, a request for the further UE capability information; receiving the further UE capability information from the UE; and determining the model to be transmitted to the UE based on the further UE capability information.

The further UE capability information may comprise at least one of: an indication of a version of the model supported by the UE; or an indication of one or more models that are stored at the UE.

The indicated one or more communication resources may be for use by the UE to receive the model from a node other than the access network node.

The node other than the access network node may be a server that stores the model, or a core network node.

The indicated communication resources may comprise at least one of a network address of the node other than the access network node, or a configuration for a radio bearer for receiving the model from the node other than the access network node.

The one or more communication resources for use by the UE to receive the model may comprise at least one of a time or frequency resource for use by the UE to receive the model.

In a case where the access network node transmits the model to the UE, the method may further comprise receiving, from the UE, an indication of whether the model has been received at the UE.

The method may further comprise determining whether the model has been received at the UE based on the indication of whether the model has been received at the UE; and retransmitting the model to the UE in a case where the access network node determines that the model has not been received at the UE.

The method may comprise transmitting the request for the UE to activate the model after transmitting the model to the UE.

The method may comprise determining that the model is stored at the UE, and transmitting the request for the UE to activate the model stored at the UE.

In another aspect the disclosure provides a method performed by a user equipment, UE, the method comprising: receiving, from an access network node, an indication of a feature for implementation in a cell of the access network node, wherein the feature is implemented using a corresponding model for generating a determination, prediction, or output parameter; determining to obtain the model; transmitting, to the access network node, a request for the model; and receiving, from the access network node, at least one of: model transmission information that includes an indication of one or more communication resources for use by the UE to receive the model; or the model.

The model may be an artificial intelligence or machine learning, AI/ML, model. Determining to obtain the model may comprise determining to obtain the model if the model is not stored at the UE.

The indication of the feature may be received from the access network node in system information.

The method may further comprise receiving, from the access network node, information indicating one or more communication resources for use by the UE to request model information corresponding to the model; transmitting a request for the model information to the access network node; and receiving the model information from the access network node.

The model information may comprise at least one of an indication of the identity of the model and a version number of the model.

The method may further comprise receiving the model from the access network node using the indicated communication resources.

The indicated communication resources may be for use by the UE to receive the model from a node other than the access network node; and wherein the method comprises receiving the model from the node other than the access network node. The node other than the access network node may be a server that stores the model, or a core network node.

The indicated communication resources may comprise at least one of a network address of the node other than the access network node, or a configuration for a radio bearer for receiving the model from the node other than the access network node.

The method may comprise transmitting, based on the indicated communication resources, to the node other than the access network node, a request for the model.

The method may further comprise transmitting, to the access network node, an indication of whether the model has been received at the UE.

In another aspect the disclosure provides a method performed by a user equipment, UE, the method comprising: transmitting, to an access network node, UE capability information that indicates at least one of: a feature supported by the UE, wherein the feature is implemented using a corresponding model for generating a determination, prediction or output parameter, a model for generating a determination, prediction or output parameter that is supported by the UE, or an indication of one or models stored at the UE; and receiving, from the access network node, at least one of: model transmission information that includes an indication of one or more communication resources for use by the UE to receive the model; the model; or a request for the UE to activate the model.

In a case where the UE receives the request for the UE to activate the model, the UE may activate the model.

The model may be an artificial intelligence or machine learning, AI/ML, model. The method may further comprise: receiving, from the access network node, a request for further UE capability information; and transmitting the further UE capability information to the access network node.

The further UE capability information may comprise at least one of: an indication of a version of the model supported by the UE; or an indication of one or more models that are stored at the UE.

The indicated one or more communication resources may be for use by the UE to receive the model from a node other than the access network node.

The node other than the access network node may be a server that stores the model, or a core network node.

The indicated communication resources may comprise at least one of a network address of the node other than the access network node, or a configuration for a radio bearer for receiving the model from the node other than the access network node.

The one or more communication resources for use by the UE to receive the model may comprise at least one of a time or frequency resource for use by the UE to receive the model.

In a case where the UE receives the model from the access network node, the method may further comprise transmitting, to the access network node, an indication of whether the model has been received at the UE.

In another aspect the disclosure provides a method performed by a user equipment, UE, the method comprising: in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE: discarding the portion of the model; transmitting, when a radio link between the UE and the access network node is re-established, a request for the model; and receiving the model from the access network node.

The model may be an artificial intelligence or machine learning, AI/ML, model.

In another aspect the disclosure provides a method performed by a user equipment, UE, the method comprising: in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE: maintaining the portion of the model in a memory of the UE 3; re-establishing a radio link between the UE and the access network node, or establishing a radio link between the UE and another access network node; in a case where the radio link is re-established between the UE and the access network node: transmitting, to the access network node, an indication of the portion of the model that is stored at the UE; and receiving, from the access network node, the remaining portion of the model; and in a case where the radio link is established with the another access network node: transmitting, to the another access network node, the indication of the portion of the model that is stored at the UE; and receiving, from the another access network node, the remaining portion of the model.

The model may be an artificial intelligence or machine learning, AI/ML, model.

When the portion of the model was received at the UE in plurality of data transfer units, each data transfer unit comprising a sub-portion the model; the indication of the portion of the model that is stored at the UE may comprise an indication of an identity of the last data transfer unit received at the UE.

The indication of an identity of the last data transfer unit received at the UE may comprise an indication of an identity of a radio resource control, RRC, segment, or an indication of an identity of a packet data convergence protocol, PDCP, sequence number, SN.

In the case where the radio link is established with the another access network, the method may further comprise: transmitting to the another access network node, at least one of: an indication of an identity of the model; or an indication of the identity of the access network node from which the UE received the portion of the model.

In the case where the radio link is re-established with the access network node, the method may further comprise transmitting, to the access network node, and indication of the identity of the model.

The UE may be in a radio resource control, RRC, connected state when the UE receives the portion of the model from the access network node; and the UE may maintain a context associated with the RRC connected state after the failure of the radio link has occurred.

In another aspect the disclosure provides a method performed by a user equipment, UE, the method comprising: receiving, from a first access network node, a portion of a model for generating a determination, prediction, or output parameter; performing a handover procedure for handover of the UE from the first access network node to a second access network node; maintaining the portion of the model in a memory of the UE 3 during the handover procedure; transmitting, to the second access network node, an indication of the portion of the model that is stored at the UE; and receiving, from the another access network node, the remaining portion of the model.

The method may further comprise receiving, from the first access network node or the second access network node, an indication that the UE is to receive the remaining portion of the model from the second access network node.

The model may be an artificial intelligence or machine learning, AI/ML, model. When the portion of the model was received at the UE from the first access network node in plurality of data transfer units, each data transfer unit comprising a sub-portion the model; the indication of the portion of the model that is stored at the UE may comprise an indication of an identity of the last data transfer unit received at the UE.

The indication of an identity of the last data transfer unit received at the UE may comprise an indication of an identity of a radio resource control, RRC, segment, or an indication of an identity of a packet data convergence protocol, PDCP, sequence number, SN.

In another aspect the disclosure provides a method performed by an access network node, the method comprising: in a case where the access network node has transmitted, to a user equipment, UE, using a radio link between the UE and the access network node, a portion of a model for generating a determination, prediction, or output parameter, and a failure of the radio link has occurred after the portion of a model has been transmitted to the UE but before a remaining portion of the model has been transmitted to the UE: re-establishing a radio link between the UE and the access network node; receiving, from the UE, an indication of a portion of the model that is stored at the UE; determining, based on the indication of a portion of the model that is stored at the UE, the remaining portion of the model to be transmitted to the UE; and transmitting, to the UE, the remaining portion of the model.

The model may be an artificial intelligence or machine learning, AI/ML, model. When the portion of the model was transmitted to the UE in plurality of data transfer units, each data transfer unit comprising a sub-portion the model; the indication of the portion of the model that is stored at the UE may comprise an indication of an identity of the last data transfer unit received at the UE.

The indication of an identity of the last data transfer unit received at the UE may comprise an indication of an identity of a radio resource control, RRC, segment, or an indication of an identity of a packet data convergence protocol, PDCP, sequence number, SN.

The UE may be in a radio resource control, RRC, connected state when the access network node transmits the portion of the model to the UE; and the access network node may maintain a context associated with the RRC connected state after the failure of the radio link has occurred.

In another aspect the disclosure provides a method performed by a first access network node, the method comprising: transmitting, to a user equipment, UE, a portion of a model for generating a determination, prediction, or output parameter; transmitting, to the UE, an indication that a remaining portion of the model is to be received from a second access network node; and performing a handover procedure for handover of the UE from the first access network node to the second access network node.

The model may be an artificial intelligence or machine learning, AI/ML, model. The method may further comprise transmitting, to the second access network node, the remaining portion of the model, for transmission of the remaining portion of the model from the second access network node to the UE.

The method may further comprise transmitting, to the second access network node, an indication of the identity of the model.

In another aspect the disclosure provides a method performed by a second access network node, the method comprising: performing a handover procedure for handover of a UE from a first access network node to the second access network node; receiving, from the UE or from the first access network node, an indication of a portion of a model for generating a determination, prediction, or output parameter that is stored at the UE, or an indication of a remaining portion of the model to be transmitted to the UE; and transmitting, to the UE, the remaining portion of the model.

The model may be an artificial intelligence or machine learning, AI/ML, model.

The method may further comprise receiving, from the first access network node, the remaining portion of the model.

The method may further comprise receiving, from the first access network node, an indication of the identity of the model.

In another aspect the disclosure provides a method performed by a user equipment, UE, the method comprising: receiving a model for generating a determination, prediction, or output parameter; determining to activate the model for use at the UE; activating the model for use at the UE; determining to transmit, to an access network node, an indication that the model has been activated for use at the UE; and transmitting, to the access network node, the indication that the model has been activated for use at the UE.

The model may be an artificial intelligence or machine learning, AI/ML, model. Determining to transmit the indication that the model has been activated for use at the UE may comprise determining to transmit the indication to the access network node when the model was received in a broadcast transmission.

In another aspect the disclosure provides a method performed by a user equipment, UE, the method comprising: receiving a model for generating a determination, prediction, or output parameter; receiving, from an access network node, an indication that the model is to be activated for use at the UE; determining, based on the indication, to activate the model for use at the UE; and activating the model for use at the UE.

The model may be an artificial intelligence or machine learning, AI/ML, model. In another aspect the disclosure provides a method of a user equipment, UE, the method comprising: receiving, from an access network node, an indication of a model for generating a determination, prediction, or output parameter that is supported for use in a cell of the access network node; and transmitting, to the access network node, an indication of whether the UE is able to receive and use the model.

The method may further comprise receiving, from the access network node, a request for the indication of whether the UE is able to receive and use the model; and transmitting the indication of whether the UE is able to receive and use the model to the access network node after receiving the request.

The model may be an artificial intelligence or machine learning, AI/ML, model. The indication of whether the UE is able to receive and use the model may comprise an indication of at least one of a state of a memory resource at the UE, a state of a processing resource at the UE, or a state of a power resource at the UE.

In another aspect the disclosure provides a method of an access network node, the method comprising: transmitting, to a user equipment, UE, an indication of a model for generating a determination, prediction, or output parameter that is supported for use in a cell of the access network node; receiving, from the UE, an indication of whether the UE is able to receive or use the model; and determining whether the model is to be transmitted to the UE, or activated for use at the UE, based on the received indication.

The model may be an artificial intelligence or machine learning, AI/ML, model.

The indication of whether the UE is able to receive and use the model may comprise an indication of at least one of a state of a memory resource at the UE, a state of a processing resource at the UE, or a state of a power resource at the UE.

In another aspect the disclosure provides an access network node comprising: means for transmitting, to a user equipment, UE, an indication of a feature for implementation in a cell of the access network node, wherein the feature is implemented using a corresponding model for generating a determination, prediction, or output parameter; means for receiving, from the UE, a request for the model; and wherein the means for transmitting is configured for transmitting, to the UE, at least one of: model transmission information that includes an indication of one or more communication resources for use by the UE to receive the model; or the model.

In another aspect the disclosure provides an access network node comprising: means for receiving, from a user equipment, UE, UE capability information that indicates at least one of: a feature supported by the UE, wherein the feature is implemented using a corresponding model for generating a determination, prediction or output parameter, a model for generating a determination, prediction or output parameter that is supported by the UE, or an indication of one or models stored at the UE; means for determining, based on the UE capability information, a model to be transmitted to, or activated at, the UE; and means for transmitting, to the UE, at least one of: model transmission information that includes an indication of one or more communication resources for use by the UE to receive the model; the model; or a request for the UE to activate the model.

In another aspect the disclosure provides a user equipment, UE, comprising: means for receiving, from an access network node, an indication of a feature for implementation in a cell of the access network node, wherein the feature is implemented using a corresponding model for generating a determination, prediction, or output parameter; means for determining to obtain the model; means for transmitting, to the access network node, a request for the model; and where in the means for receiving is configured for receiving, from the access network node, at least one of: model transmission information that includes an indication of one or more communication resources for use by the UE to receive the model; or the model.

In another aspect the disclosure provides a user equipment, UE, comprising: means for transmitting, to an access network node, UE capability information that indicates at least one of: a feature supported by the UE, wherein the feature is implemented using a corresponding model for generating a determination, prediction or output parameter, a model for generating a determination, prediction or output parameter that is supported by the UE, or an indication of one or models stored at the UE; and means for receiving, from the access network node, at least one of: model transmission information that includes an indication of one or more communication resources for use by the UE to receive the model; the model; or a request for the UE to activate the model.

In another aspect the disclosure provides a user equipment, UE, configured for, in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE: discarding the portion of the model; transmitting, when a radio link between the UE and the access network node is re-established, a request for the model; and receiving the model from the access network node.

In another aspect the disclosure provides a user equipment, UE, configured for, in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE: maintaining the portion of the model in a memory of the UE 3; re-establishing a radio link between the UE and the access network node, or establishing a radio link between the UE and another access network node; in a case where the radio link is re-established between the UE and the access network node: transmitting, to the access network node, an indication of the portion of the model that is stored at the UE; and receiving, from the access network node, the remaining portion of the model; and in a case where the radio link is established with the another access network node: transmitting, to the another access network node, the indication of the portion of the model that is stored at the UE; and receiving, from the another access network node, the remaining portion of the model.

In another aspect the disclosure provides a user equipment, UE, comprising: means for receiving, from a first access network node, a portion of a model for generating a determination, prediction, or output parameter; means for performing a handover procedure for handover of the UE from the first access network node to a second access network node; means for maintaining the portion of the model in a memory of the UE 3 during the handover procedure; means for transmitting, to the second access network node, an indication of the portion of the model that is stored at the UE; and means for receiving, from the another access network node, the remaining portion of the model.

In another aspect the disclosure provides an access network node configured for, in a case where the access network node has transmitted, to a user equipment, UE, using a radio link between the UE and the access network node, a portion of a model for generating a determination, prediction, or output parameter, and a failure of the radio link has occurred after the portion of a model has been transmitted to the UE but before a remaining portion of the model has been transmitted to the UE: re-establishing a radio link between the UE and the access network node; receiving, from the UE, an indication of a portion of the model that is stored at the UE; determining, based on the indication of a portion of the model that is stored at the UE, the remaining portion of the model to be transmitted to the UE; and transmitting, to the UE, the remaining portion of the model.

In another aspect the disclosure provides a first access network node comprising: means for transmitting configured for: transmitting, to a user equipment, UE, a portion of a model for generating a determination, prediction, or output parameter, and transmitting, to the UE, an indication that a remaining portion of the model is to be received from a second access network node; and means for performing a handover procedure for handover of the UE from the first access network node to the second access network node.

In another aspect the disclosure provides a second access network node comprising: means for performing a handover procedure for handover of a UE from a first access network node to the second access network node; means for receiving, from the UE or from the first access network node, an indication of a portion of a model for generating a determination, prediction, or output parameter that is stored at the UE, or an indication of a remaining portion of the model to be transmitted to the UE; and means for transmitting, to the UE, the remaining portion of the model.

In another aspect the disclosure provides a user equipment, UE, comprising: means for receiving a model for generating a determination, prediction, or output parameter; means for determining to activate the model for use at the UE; means for activating the model for use at the UE; means for determining to transmit, to an access network node, an indication that the model has been activated for use at the UE; and means for transmitting, to the access network node, the indication that the model has been activated for use at the UE.

In another aspect the disclosure provides a user equipment, UE, comprising: means for receiving configured for: receiving a model for generating a determination, prediction, or output parameter; and receiving, from an access network node, an indication that the model is to be activated for use at the UE; means for determining, based on the indication, to activate the model for use at the UE; and means for activating the model for use at the UE.

In another aspect the disclosure provides user equipment, UE, comprising: means for receiving, from an access network node, an indication of a model for generating a determination, prediction, or output parameter that is supported for use in a cell of the access network node; and means for transmitting, to the access network node, an indication of whether the UE is able to receive and use the model.

In another aspect the disclosure provides an access network node comprising: means for transmitting, to a user equipment, UE, an indication of a model for generating a determination, prediction, or output parameter that is supported for use in a cell of the access network node; means for receiving, from the UE, an indication of whether the UE is able to receive or use the model; and means for determining whether the model is to be transmitted to the UE, or activated for use at the UE, based on the received indication.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 is a schematic block diagram illustrating the main components of a DU 50 that may be used as part of the RAN base station 5 for the communication system 1 shown in FIG. 1;

FIG. 4 is a schematic block diagram illustrating the main components of a CU 60 that may be used as part of the RAN base station 5 for the communication system 1 shown in FIG. 1;

FIG. 5 shows a mobility procedure in which handover occurs from a source base station to a target base station;

FIG. 6 shows a random access (RA) procedure that may be performed in the system of FIG. 1;

FIG. 7 shows a schematic illustration of point to point and point to multipoint transmissions;

FIG. 8 illustrates a framework in respect of an AI/ML model;

FIG. 9 shows an illustration of a method of training an AI/ML model, and of monitoring the performance of the AI/ML model;

FIG. 10 shows an example of an AI/ML request and an AI/ML response;

FIG. 11 shows an example of an AI/ML information update;

FIG. 12 shows an example of a method in which the base station 5 broadcasts an indication of supported AI/ML models;

FIG. 13 shows an example in which an AI/ML model is transmitted to the UE from an AI/ML server via a base station;

FIG. 14 shows an example in which an AI/ML model is transmitted to the UE from a CU of a distributed base station via a DU;

FIG. 15 shows an example in which the network is configured to use paging to notify one or more UEs of an update to an AI/ML model;

FIG. 16 shows an example of AI/ML model function areas;

FIG. 17 illustrates a method in which AI/ML model area information is received by a UE;

FIG. 18 shows a method in which an AI/ML model is transmitted to a UE 3 by a base station;

FIG. 19 shows a modification of the example of FIG. 18 in which the AI/ML model is transmitted from the base station to the UE without providing a separate indication of the communication resources for the AI/ML model transmission;

FIG. 20 shows a modification of the example of FIG. 18 in which the AI/ML model is transmitted from an AI/ML server to the UE;

FIG. 21 shows an example in which the UE transmits UE AI/ML capability information to the base station 5 and receives the AI/ML model from the base station;

FIG. 22 shows an example in which the UE transmits UE AI/ML capability information to the base station, and the AI/ML model is transmitted from the base station to the UE without providing a separate indication of the communication resources for the AI/ML model transmission;

FIG. 23 shows an example in which the UE 3 transmits UE AI/ML capability information to the base station 5, and the AI/ML model is transmitted from an AI/ML server to the UE;

FIG. 24 is a schematic block diagram illustrating the main components of a UE for the telecommunication system of FIG. 1;

FIG. 25 is a schematic block diagram illustrating the main components of a base station for the telecommunication system of FIG. 1; and

FIG. 26 is a schematic block diagram illustrating the main components of a core network node or function for the telecommunication system of FIG. 1.

### DESCRIPTION OF EMBODIMENTS

### Overview

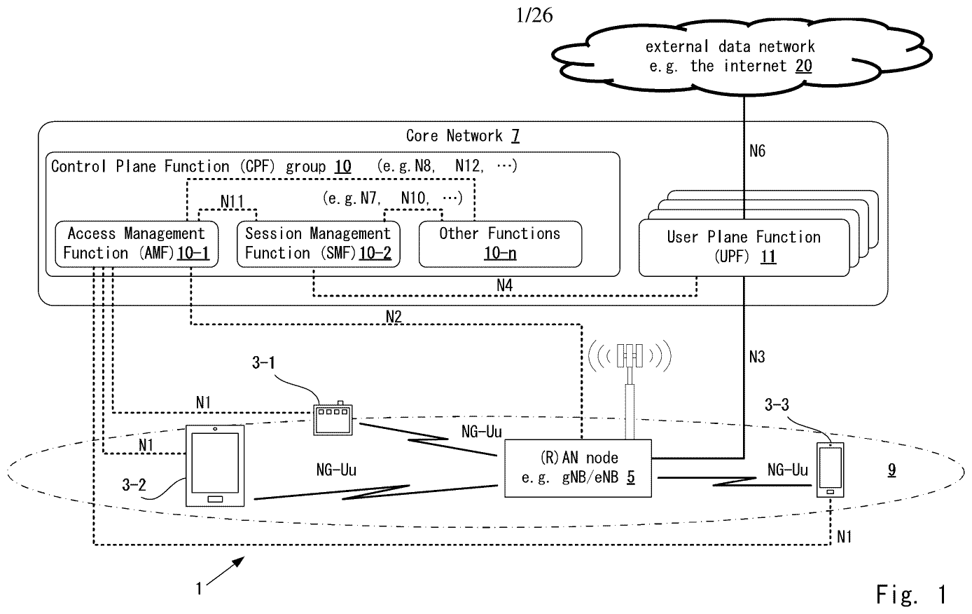

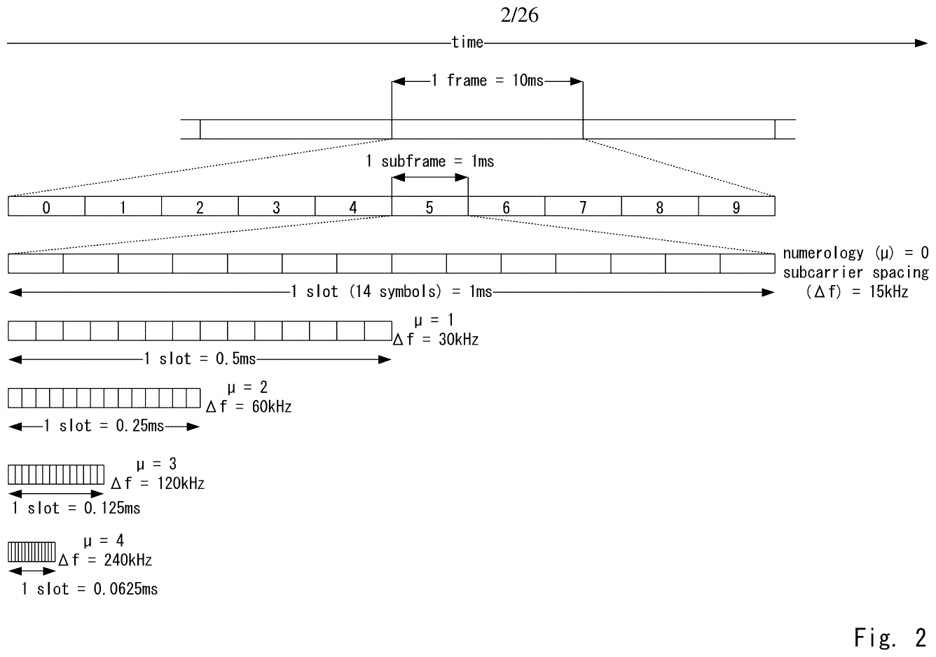

An exemplary telecommunication system will now be described in general terms, by way of example only, with reference to FIGS. 1 and 2.

FIG. 1 schematically illustrates a mobile (‘cellular’ or ‘wireless’) telecommunication system 1 to which example embodiments of the present disclosure are applicable.

In the network 1 user equipment (UEs) 3-1, 3-2, 3-3 (e.g. mobile telephones and/or other mobile devices) can communicate with each other via a (radio) access network ((R)AN) node 5 that operates according to one or more compatible radio access technologies (RATs). In the illustrated example, the (R)AN node 5 comprises a NR/5G base station 5 or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls the one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2 and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

The one or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicityServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes a radio resource control (RRC) connection with a base station 5 via a cell 9 it registers with an appropriate core network node (e.g., AMF, MME). The UE 3 is in the so-called RRC connected state and an associated UE context is maintained by the network. When the UE 3 is in the so-called RRC idle state, or is in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station 5 may be referred to as a ‘distributed’ base station 5 or gNB 5. A distributed gNB 5 includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the control-plane and user-plane entities may each include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### Frame Structure

Referring to FIG. 2, which illustrates a typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2^{μ} kHz). The relationship between the parameter, μ, and SCS (Δf) is as shown in Table 1

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### (R)AN Node

### DU

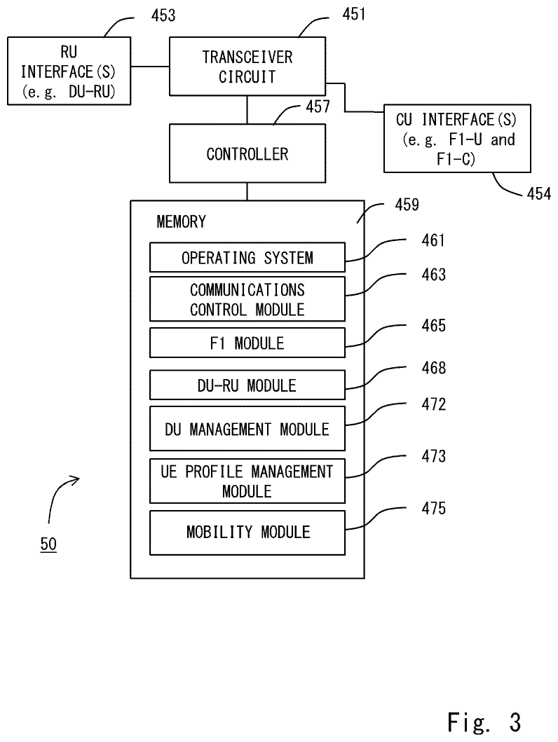

FIG. 3 is a schematic block diagram illustrating the main components of a DU 50 that may be used as part of the (R)AN node 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the (R)AN node 5 via a CU interface 454 (e.g. comprising an F1 interface which may be split into an F1-U and an F1-C interface for user plane and control plane signalling respectively).

The DU 50 has a controller 457 for controlling the operation of the DU 50. The controller 457 is associated with a memory 459. Software may be pre-installed in the memory 459 and/or may be downloaded via the communication system 1 or from a removable data storage device (RMD) for example. The controller 457 is configured to control the overall operation of the DU 50 by, in this example, program instructions or software instructions stored within memory 459.

As shown, these software instructions include, among other things, an operating system 461, a communications control module 463, an F1 module 465, a DU-RU module 468, a DU management module 472, a UE profile management module 473 and a mobility module 475.

The communications control module 463 is operable to control the communication between the DU 50 and the one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications to the UE 3.

The F1 module 465 is responsible for the appropriate processing of signals received from, or transmitted to, the CU 60 via the one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via the one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission. The DU management module 472 may control the overall operation of the DU 50 in accordance with any of the methods describe below, where appropriate.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or (R)AN node 5; and/or the provision of configuration information (where applicable) for configuring the UE appropriately with mobility based configurations. The UE profile management module 473 may also store, for example, previous mobility information for a UE 3 (e.g. previous movements of the UE 3 between different communication cells of the network). It will be appreciated that, depending on implementation, the DU 50 may not implement at least some of these features.

The mobility module 475 is responsible for controlling mobility procedures for one or more UEs 3. For example, the mobility module 475 may be configured to perform one or more measurements for UE 3 mobility, or to select a candidate cell for handover.

### CU

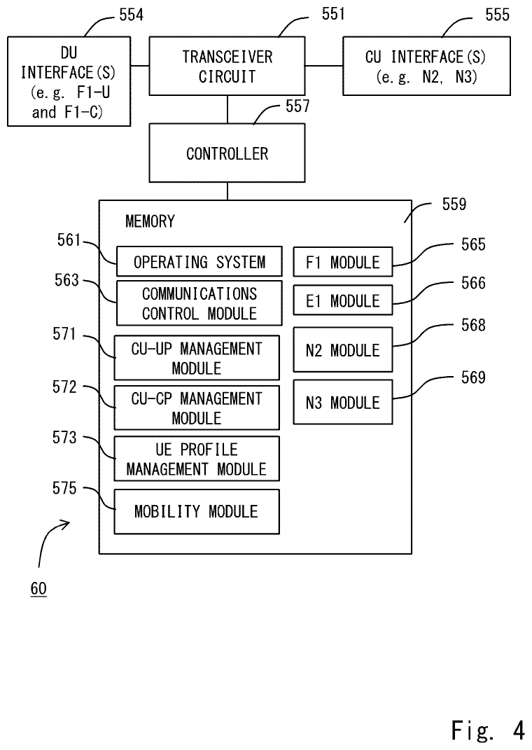

FIG. 4 is a schematic block diagram illustrating the main components of the CU 60 of the (R)AN node for the communication system 1 shown in FIG. 1. As shown, the CU 60 has a transceiver circuit 551 for: transmitting signals to, and for receiving signals from, the DU 50 via the one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more CU network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communication system 1 or from a removable data storage device (RMD) for example. The controller 557 is configured to control the overall operation of the CU 60 by, in this example, program instructions or software instructions stored within memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and a mobility module 575. The functions of the mobility module 575 are the same as described above with reference to FIG. 3.

The communications control module 563 is operable to control the communication between the CU 60 and the one or more DUs 50 (and hence between the CU 60 and the UE 3), and between the CU 60 and the core network 7. The communications control module 563 is configured for the overall control of the reception of signals corresponding to uplink communications from the UE 3 and for controlling the transmission of downlink communications.

The F1 module 565 is responsible for the appropriate processing of signals received from, or transmitted to, the DU 50 via the one or more DU (e.g. F1) interfaces 554. These signals include: user plane signals received at, or transmitted by, the CU-UP part of the CU 60 via the F1-U interface; and control plane signals received at, or transmitted by, the CU-CP part of the CU 60 via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via the one or more corresponding CU interfaces (e.g. N2) 555.

The N3 module 569 is responsible for the appropriate processing of signals received from, or transmitted to, the one or more core network user plane functions via the one or more corresponding CU interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or (R)AN node 5; and/or the provision of configuration information for configuring the UE appropriately with mobility based configurations. The UE profile management module 573 may also store previous mobility information for a UE 3 (e.g. previous movements of the UE 3 between different communication cells of the network). It will be appreciated that, depending on implementation, the CU 60 may not implement at least some of these features.

### System Information and SIB

It will be appreciated that transmissions in a cell 9 of a base station 5 may include one or more broadcast transmissions, one or more unicast transmissions for reception by a UE 3, and/or one or more multicast transmissions for reception by a group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by the UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions (e.g. another dedicated RRC message). The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. SIB2 provides information for intra-frequency, inter-frequency and inter-system cell reselection. SIB3 provides cell-specific information for intra-frequency cell reselection. SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIBI may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using message 1 (MSG1), which may be referred to as a MSG1-based on-demand SI request, or message 3 (MSG3), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block comprises 240 contiguous subcarriers. When the UE 3 is in an RRC connected state, the base station 5 may provide the UE 3 with an indication of resources used for the SS/PBCH, for example using dedicated signalling. SIB1 may be transmitted using a physical downlink shared channel (PDSCH). The OSI may be similarly transmitted, for example, using a PDSCH. When one or more beamformed transmissions are transmitted in a cell provided by the base station 5, some of the SI (e.g. some of the SIB) may only be transmitted using particular beams, or using a particular transmission/reception point (TRP).

### UE Mobility

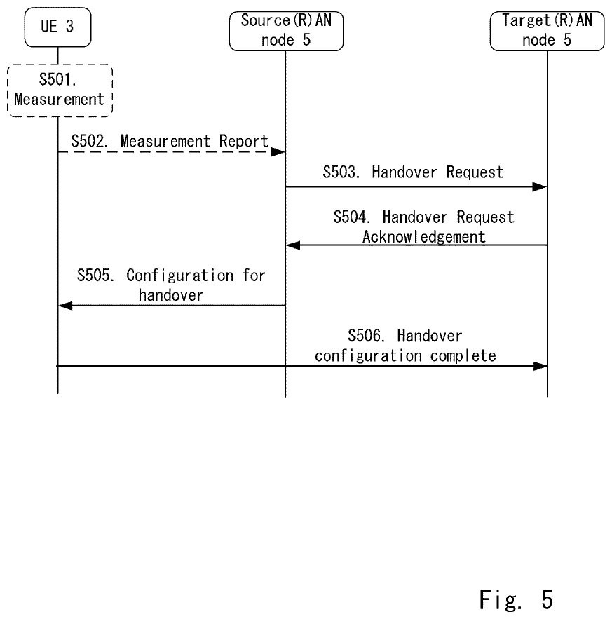

FIG. 5 shows an overview of a mobility procedure that may be performed in a communication system 1 of the type illustrated in FIG. 1. In this example, a handover of a UE 3 from a source base station 5 to a target base station 5 is performed.

In optional step S501 the UE 3 performs a measurement. The measurement may be a measurement of a signal transmitted by the source (R)AN node 5 or a measurement of a signal transmitted by the target (R)AN node 5. The measurement may be a measurement of a signal strength, that can be used as part of a determination that the UE 3 is to be handed over from the source (R)AN node 5 to the target (R)AN node 5. In optional step S502 the UE 3 transmits a measurement report to the source (R)AN node 5 that provides an indication of the result of the measurement. The measurement report may be transmitted from the UE 3 to the source base station 5 in an RRC message. In this example the source (R)AN node 5 uses the information provided in the measurement report to determine that the UE 3 is to be handed over to the target (R)AN node 5. However, it will be appreciated that a determination that handover to the target (R)AN node 5 is to be performed may alternatively (or additionally) be based on a measurement performed at the source (R)AN node 5 or at the target (R)AN node 5. Alternatively, a determination that handover of the UE 3 is to be performed may be based on a factor other than a signal measurement, such as a level of congestion in a cell operated by the source (R)AN node 5, or an inference (e.g. determination or prediction) generated using an AI/ML model.

In Step S503 the source (R)AN node 5 transmits a handover request to the target (R)AN node 5, requesting handover of the UE 3 from the source (R)AN node 5 to the target (R)AN node 5. The handover request may include an indication of, for example, an identity of the source (R)AN node 5, a cause value for the handover, an identity of the target cell, UE 3 context information (e.g. a maximum bit rate of the UE 3, or security capabilities of the UE 3), and UE history information. If the handover has been triggered by the measurement report received by the source (R)AN node 5 in step S502, then the cause value may indicate, for example, that the handover is desirable for radio reasons. Alternatively, if the handover has been triggered to reduce the load at the source (R)AN node 5, the cause value may indicate that the handover is for reducing load in the serving cell. The handover request message may also include an indication of the AMF 10-1 that is serving the UE 3.

In step S504, the target (R)AN node 5 transmits an acknowledgement of the handover request (which may be referred to as a “handover request acknowledgement” message). The handover request acknowledgement message includes an indication of handover configuration information for the handover that is to be forwarded to the UE 3. The handover request acknowledgement message may also include configuration information that enables the source (R)AN node 5 to begin forwarding user plane data for the UE 3 to the target (R)AN node 5.

The transmissions of steps S503 and S504 may be performed over an Xn interface between the source (R)AN node 5 and the target (R)AN node 5 (and therefore the handover procedure in this example may be referred to as an Xn-based handover procedure). Steps S501 to S504 may be referred to as a ‘handover preparation phase’.

In step S505, the source (R)AN node 5 transmits the handover configuration information to the UE 3. The configuration information for the handover may be, for example, an RRC configuration transmitted in an RRC configuration message or an RRC reconfiguration message. In step S506, the UE 3 applies the received configuration for handover and transmits an indication to the target (R)AN node 5 that configuration for the handover is complete. The message transmitted in step S505 may be, for example, an RRC Reconfiguration Complete message. Steps S505 and S506 may be referred to as a ‘handover execution phase’.

Following the handover execution phase, the UE 3 is operable to transmit uplink transmissions to the target (R)AN node 5 (e.g., uplink data) and receive downlink transmissions from the target (R)AN node 5 (e.g. downlink data).

It will be appreciated that mobility methods and handover procedures for the UE 3 are not restricted to the example illustrated in FIG. 5. For example, the UE 3 may be configured to perform a conditional handover (CHO) in which the UE 3 determines whether handover of the UE 3 to a candidate cell is to be performed based on one or more execution conditions. It will also be appreciated that handover may be performed in which the DU 50 changes but the CU 60 remains the same (inter-DU intra-CU handover), in which both the DU 50 and CU 60 change (inter-DU inter-CU handover), or between two cells operated by the same DU 50.

### Random Access

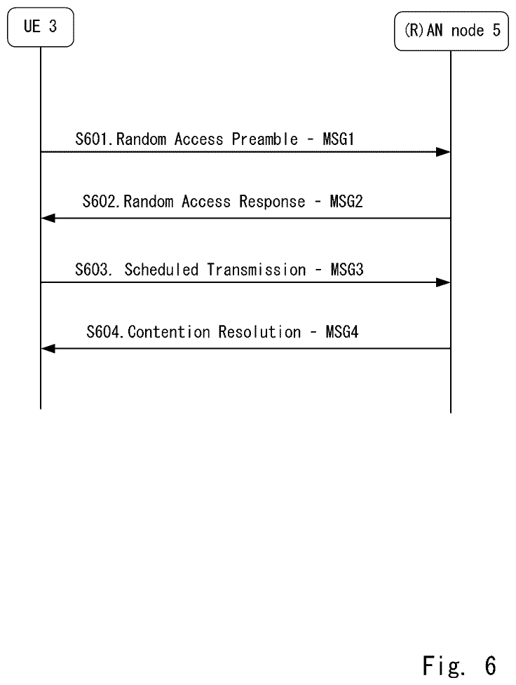

FIG. 6 shows a random access (RA) procedure that may be performed in the system of FIG. 1. The RA procedure can be used, for example, for initial access by a UE 3 that is in the RRC idle mode, or for a transition from the RRC inactive mode to the RRC connected mode. The RA procedure may also be used during handover of the UE 3 from a source base station to a target base station (e.g. the handover procedure described above with reference to FIG. 5), for initial access to the target base station 5.

In step S601 the UE 3 transmits a random access preamble to the base station 5. In this example the UE 3 selects the random access preamble to transmit from a group of random access preambles that are shared with other UEs 3. The transmission of step S601 may be referred to as message 1 (MSG1), and is transmitted using PRACH.

In step S602 the base station 5 transmits a random access response to the UE 3. The transmission of step S602 may be referred to as message 2 (MSG2). The random access response indicates time and/or frequency resources (e.g. resource blocks and/or symbols) for use by the UE 3 to transmit a subsequent transmission to the base station 5. The random access response may also include further information for use by the UE 3 for communication with the base station 5, such as a timing advance (TA) value.

In step S603 the UE 3 transmits a transmission to the base station 5 using the indicated time and/or frequency resources. The transmission of step S603 may be referred to as message 3 (MSG3). The transmission of step S603 may be a layer 2 (L2) or layer 3 (L3) message. The transmission of step S603 may comprise, for example, an RRC setup request, an RRC resume request, an RRC reestablishment request, or an RRC reconfiguration complete message.

If two UEs 3 selected and transmitted the same random access preamble in step S601, and receive and decode MSG2 transmitted by the base station 5 in step S602, then the two UEs may transmit MSG3 using the same time and/or frequency resources. This situation can be referred to as ‘contention’ or ‘collision’. In order to resolve the contention, in step S604 the base station 5 transmits a content resolution message to the UE 3. The transmission of step S604 may be referred to as message 4 (MSG4). MSG4 indicates to the UE 3 whether the MSG3 transmitted by the UE 3 in step S603 was received and successfully decoded by the base station. MSG3 transmitted in step S603 may not have been received or successfully decoded by the base station 5 if the base station 5 decoded a MSG3 transmitted by another UE 3 that is in contention with the UE 3, or if interference occurred between the MSG3 transmitted by the two UEs 3. If MSG3 transmitted by the UE 3 was not decoded by the base station 5 (which the UE 3 may determine if the UE 3 does not receive MSG4 from the base station 5), then the UE 3 returns to step S601 of the method and transmits another MSG1 to the base station 5 (e.g. after selecting a different random access preamble).

The procedure illustrated in FIG. 6 is an example of a contention based RA procedure in which the UE 3 selects the random access preamble from a group of preambles that could also be used by other UEs 3 (and therefore contention can occur if two of the UEs 3 select the same random access preamble). Alternatively, the base station 5 may transmit a random access preamble assignment to the UE 3 before the UE 3 transmits MSG 1 to the base station 5, in which case the RA procedure is contention free (and the contention resolution in step S604 need not be performed). The random access preamble assignment may be transmitted to the UE 3 using an RRC message or layer 1 (L1) signalling (e.g. using DCI carried by a PDCCH). In the method illustrated in FIG. 5, a random access preamble assignment for communication with the target base station 5 may be transmitted to the UE 3 in step S505.

MSG1 and/or MSG 3 may be used by the UE 3 to request on-demand SI from the base station 5.

### Broadcasts and Multicasts

A base station 5 may transmit a broadcast intended for reception by any UE 3 in a cell of the base station 5, or may transmit a transmission intended for reception by a particular UE 3 (a point to point, PTP, transmission). The base station 5 may also transmit a transmission intended for reception by a particular group of UEs 3 (a point to multiple, PTM, transmission). A transmission intended for reception by a single UE 3 may be referred to as a unicast transmission, and a transmission intended for reception by a group of UEs 3 may be referred to as a multicast transmission.

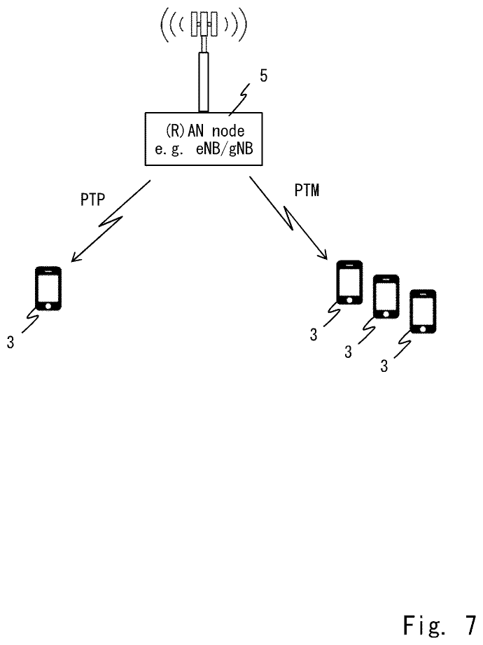

A multicast service may include a PTP leg between a base station 5 and a single UE 3, and a PTM leg between the base station 5 and a plurality of UEs 3. PTP and PTM transmissions are illustrated schematically in FIG. 7. It will be appreciated that whilst the UEs 3 are shown separately in FIG. 7, a UE 3 may receive both the PTP and PTM parts of the multicast. PTP may be described as a PTP ‘leg’ or ‘part’ of a multicast transmission. Similarly, PTM may be described as a PTM ‘leg’ or ‘part’ of a multicast transmission.

The PTM leg has an MBS radio bearer (MRB) that has a corresponding MRB configuration. Each MRB may have an associated identifier (e.g. MRB-Identity) that can be used to identify the MRB. The MRB identity may be included in any suitable transmission for MRB configuration. A multicast service may be suspended (a process in which MRBs are released) or re-activated based on multicast data activity (or inactivity). The configuration of the one or more MRBs may be provided to the UE 3 and/or the base station using any suitable radio link control (RLC) configuration signalling (e.g. in an RLC Bearer Configuration message).

The base station 5 may provide a multicast MRB configuration to the UE 3 via dedicated signalling. The multicast MRB may be configured in a DL only RLC unacknowledge mode (RLC-UM), in which acknowledge/negative-acknowledge (ACK/NACK) feedback is not transmitted, or the MRB may have a bidirectional RLC-UM configuration for PTP transmission.

The multicast MRB configuration may include an RLC-acknowledge mode (RLC-AM) configuration for transmission of ACK/NACK feedback. The multicast MRB configuration may include an RLC-unacknowledge mode (RLC-UM) configuration in which ACK/NACK feedback is not transmitted.

The multicast MRB configuration may include an RLC-AM entity for PTP transmission. The multicast MRB configuration may include a DL only RLC-UM entity for PTM transmission.

The multicast MRB configuration may include two RLC-UM entities. One of the RLC-UM entities may be a DL only RLC-UM entity for PTP transmission, and the other RLC-UM entity may be a DL only RLC-UM entity for PTM transmission.

The multicast MRB configuration may include three RLC-UM entities, wherein one of the RLC-UM entities is a DL only RLC-UM entity, one of the RLC-UM entities is an UL RLC-UM entity for PTP transmissions, and the other RLC-UM entity is a DL only RLC-UM entity for PTM transmission.

The multicast MRB configuration may include two RLC entities, wherein one of the RLC entities is an RLC-AM entity for PTP transmission, and the other RLC entity is a DL only RLC-UM entity for PTM transmission.

### Logical Channels and Logical Channel Priority

A logical channel (LCH) may be a control channel for the transmission of control and/or configuration information (control plane information), or may be a channel used for transmission of user data (user plane information). Logical channels that may be used in the system illustrated in FIG. 1 include the broadcast control channel (BCCH), the paging control channel (PCCH), the common control channel (CCCH) used by the UE 3 during initial access, the dedicated control channel (DCCH) and the dedicated traffic channel (DTCH). One or more transport channels may also be used in the system of FIG. 1. Transport channels include the broadcast channel (BCH), paging channel (PCH), downlink shared channel (DLSCH), uplink shared channel (ULSCH) and random access channel (RACH). Mapping between the logical channels and the transport channels may be performed at the medium access control (MAC) layer, and multiple logical channels may be multiplexed for transmission using a transport channel (e.g. based on the priority of each logical channel, as described later). For example, the BCCH may be mapped to the BCH or the DLSCH, and the PCCH may be mapped to the PCH. The transport channels are mapped to corresponding physical channels (e.g.: PDCCH, PDSCH or PBCH for downlink transmissions; or PUSCH, PUCCH or PUSCH for uplink transmissions).

A logical channel may be identified using a corresponding logical channel ID (LCID). A set of logical channels may be grouped into a logical channel group (LCG), which can be identified using a corresponding index (e.g. an index between 0 and 7).

A logical channel can be assigned a priority by the network (e.g. a transmission priority). For example, a logical channel being used for part of a handover procedure may be assigned a relatively high priority for transmission, since transmission delays in the handover procedure increase the likelihood of handover failure. The base station 5 may determine to preferentially include data (or other information) corresponding to a higher priority logical channel in a medium access control (MAC) protocol data unit (PDU) for transmission to the UE 3, rather than including data or other information corresponding to a lower priority logical channel. The base station 5 may also control the scheduling of uplink transmissions by the UE 3 based on the logical channel priorities.

A prioritised bit rate (PBR) may be defined for a logical channel. The prioritised bit rate may be configured by the base station 5. The prioritised bit rate is a bit rate configured for use for a higher priority logical channel, and the remaining available bit rate (or a portion of the remaining available bit rate) is configured for transmission of the lower priority logical channels. Use of the PBR beneficially helps to avoid a situation in which only the highest priority logical channels are transmitted.

### Artificial Intelligence (AI)/Machine Learning (ML)

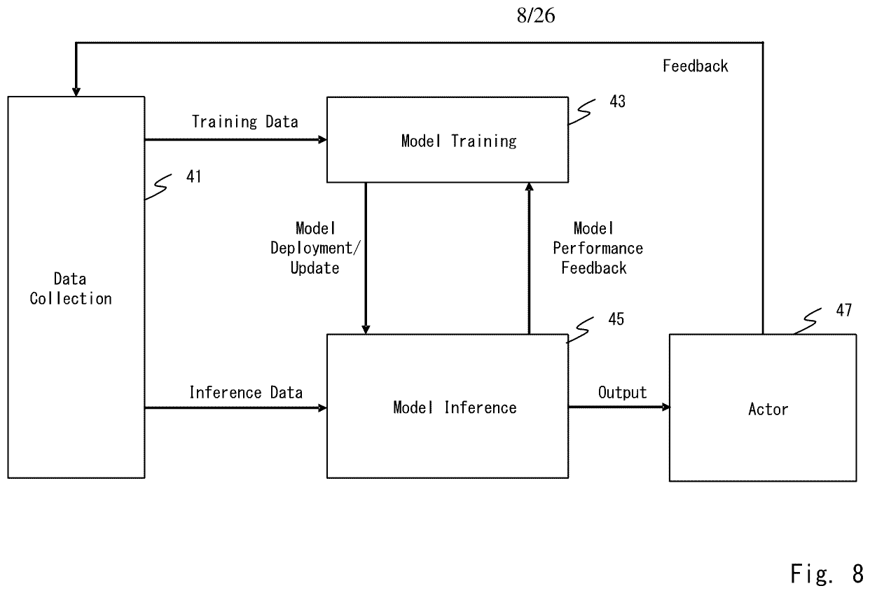

FIG. 8 illustrates a framework in respect of an AI/ML model, and how various entities of the framework may interact with one another.

The entities include a data collection function 41, a model training function 43, a model inference function 45, and an actor 47. The data collection function 41 provides input data (training data) to the model training function 43 and the model inference function 45. The collected data may be, for example, data regarding mobility (e.g. handover of a UE 3, or a location of the UE 3). For example, the data may be obtained by a base station 5 (e.g. by receiving a measurement report from a UE 3, or by receiving data from another base station 5 or a core network node/function) and transmitted to another base station 5 that generates the AI/ML model inference output (or alternatively, the same base station that obtains the data may generate the AI/ML model output). The model training function 43 performs the ML model training, validation, and testing, and may generate model performance metrics as part of a model testing procedure. The model inference function 45 provides AI/ML model inference output (e.g., predictions or decisions), and the actor 47 is a function or node that receives the output from the model inference function 45 and triggers or performs corresponding actions (e.g. a base station 5 that increases/reduces its transmit power, or initiates a handover procedure for a UE 3). The AI/ML model inference output may be, for example, a prediction of mobility (e.g. expected path, route or trajectory, inter-cell or inter-beam mobility, or expected handover) of the UE 3, or one or more parameters for use in encoding or decoding transmissions between the base station 5 and the UE 3. The functions illustrated in FIG. 8 may be co-located at a single node of the communications network (e.g. at a base station 5 or core network node/function), or may be distributed amongst a plurality of network nodes (e.g. a plurality of base stations 5).

Terms referred to by 3GPP in the context of this framework include:
AI/ML Training: An online or offline process for training an AI/ML model.
AI/ML Validation: A method for evaluating the quality (e.g. prediction accuracy) of an AI/ML model using a dataset that is different from the one used for the training of the model.
AI/ML Model Testing: A method for evaluating the performance of a final AI/ML model, using a dataset different from the ones used for training and validation.
AI/ML Data Collection: A method of collecting data by network nodes, a management entity, and/or a UE 3, for training the AI/ML model, for data analytics (e.g. model performance monitoring), and/or for generating an inference using the AI/ML model.
Model Monitoring: A method of monitoring the inference performance (e.g. prediction accuracy) of the AI/ML model.
Training Data: Data for input to the AI/ML Model Training function.
Supervised Learning: A method of training an AI/ML model using labelled data.
Unsupervised Leaning: A method of training an AI/ML model using unlabelled data.
Semi-supervised Learning: A method of training an AI/ML model using both labelled and unlabelled data.
Inference Data: Data for input to the AI/ML Model Inference function, for generating an inference.
Model Deployment/Update: A method of deploying (e.g. transmitting to a network node) an AI/ML model to the Model Inference function, or of delivering an updated model to the Model Inference function.

The data collection 41 may be performed at various nodes of the communication network (e.g. at one or more base stations 5 or UEs 3).

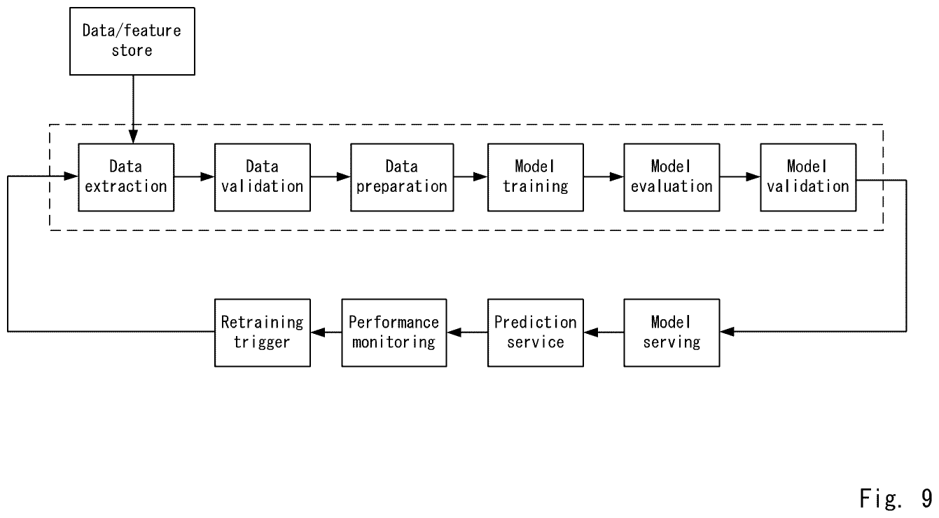

FIG. 9 shows an illustration of a method of training an AI/ML model, and of monitoring the performance of the AI/ML model. As illustrated in FIG. 9, stored data/features may first be extracted in a data extraction step. In the data validation step, a determination of whether to proceed with training or retaining the AI/ML model is made (e.g., based on the extracted data). In the data preparation stage, the data is prepared for use in training the AI/ML model. For example, the data may be cleaned (e.g. filtered), subject to a transformation, or modified in any other suitable manner. The data may also be divided in training data, validation data and test data sets in the data preparation stage.

In the model training step, the AI/ML model is trained (or retrained) using training data prepared in the data preparation step. It will be appreciated that any suitable training method can be used to train the AI/ML model (e.g., a method that comprises supervised learning or unsupervised learning). In the model evaluation step, the AI/ML model is evaluated (e.g. a prediction accuracy of the AI/ML model is evaluated) using a test data set (which may be generated in the data preparation step). In the model validation step, a determination of whether the AI/ML model is suitable for deployment in the communication network is made (e.g. based on the results of the model evaluation step).

In the model serving step, the AI/ML model is deployed for use in the communication network 1. AI/ML model deployment may comprise compiling a trained AI/ML model, packaging the model into an executable format, and delivering the AI/ML model to a target device. For example, the AI/ML model may be transmitted to the base station 5 and/or the UE 3, for use at the base station and/or the UE to generate predictions or determinations using the AI/ML model as part of a prediction service step, as illustrated in the figure. In the performance monitoring step, the performance of the deployed AI/ML model is monitored. The predictive performance of the AI/ML model may be monitored by comparing predictions generated using the model with one or more measurements. For example, when the AI/ML model is used to predict a location of a UE 3, the prediction accuracy of the AI/ML model may be assessed using a measurement of an actual location of the UE 3. Alternatively, if the AI/ML model is used for determining parameters for use in encoding and decoding data transmitted between a base station 5 and a UE 3, the model may be assessed based on the performance of the encoding and/or decoding processes. In the retraining trigger step, retraining of the AI/ML model is triggered (e.g. because the prediction accuracy of the AI/ML model has fallen below an acceptable threshold accuracy, or because a performance of a method that uses inferences from the AI/ML model has fallen below an acceptable threshold performance), and the method returns to the data extraction step.

As described above with reference to FIG. 8, each step of the method of FIG. 9 may be executed at a single node of the communication system 1, or alternatively steps of the method may be distributed between a plurality of different nodes.

As discussed above with reference to FIGS. 8 and 9, information collected by nodes/functions in the communication network can be used as training data for an AI/ML model, and used as inference data for use in generating one or more model inferences using the AI/ML model. The information used as training data and/or to generating the one or more model inferences may be referred to as ‘AI/ML information’. Methods of requesting and transmitting AI/ML information will now be described.

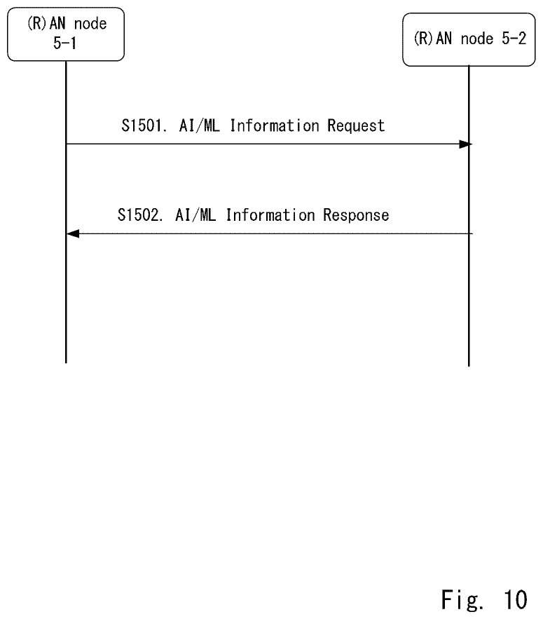

FIG. 10 shows an example of an AI/ML information request and an AI/ML response. In Step S1501, the first base station 5-1 transmits an AI/ML information request to the second base station 5-2. The AI/ML request is a request for AI/ML information (e.g. information regarding an actual mobility of a UE 3) from the second base station 5-2.

After receiving the AI/ML information request in step S1501, the second base station 5-2 transmits an AI/ML Information Response to the first base station 5-1 that includes the AI/ML information. The second base station 5-2 may also begin periodic reporting of the AI/ML information to the first base station 5-1 in response to receiving the AI/ML information request. The periodic reporting may be configured using a corresponding AI/ML information reporting configuration indicated by the AI/ML information request (e.g. including a periodicity of the reporting, number of reports, or reporting duration/time period). The AI/ML information request may include an information element (IE) that indicates that the second base station 5-2 is to start or stop periodic reporting of the AI/ML information to the first base station 5-1. The AI/ML information request may alternatively be a request for a single report of AI/ML information from the second base station 5-2, rather than for periodic reporting.

If the second base station 5-2 is unable to transmit the requested AI/ML information to the first base station 5-1 (e.g. because the requested information is not available at the second base station 5-2), then the second base station 5-2 may transmit a corresponding indication to the first base station 5-1 that the second base station 5-2 is unable to provide the requested information, for example an AI/ML information failure message. The AI/ML information failure message may include an indication of why the second base station 5-2 is unable to provide the requested AI/ML information (e.g. a cause value).

Upon receipt of the AI/ML information, the first base station 5-1 may use the AI/ML information to train (or update) a corresponding AI/ML model (e.g. for UE 3 mobility), or to generate a prediction (e.g., a prediction of UE 3 mobility). Alternatively, the first base station 5-1 may forward the AI/ML information to another network node, for use with an AI/ML model at that network node.

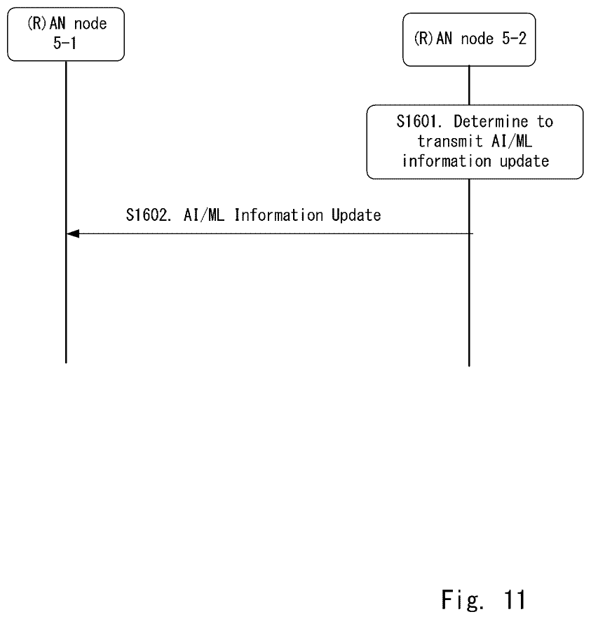

Whilst in the example shown in FIG. 10 the AI/ML information response may include the requested AI/ML information, alternatively the AI/ML information response may be an indication that the second base station 5-2 will transmit the AI/ML information in a subsequent AI/ML information update (e.g. an acknowledgement of the AI/ML information request). FIG. 11 shows an example of an AI/ML information update. In step S1601 the second base station 5-2 determines to transmit an AI/ML information update to the first base station 5-1. For example, the second base station 5-2 may determine to transmit the AI/ML information update to the first base station 5-2 based on a reporting periodicity received by the second base station 5-2 in step S1501 of FIG. 10, or may determine to transmit the AI/ML information update based on a change in AI/ML information stored at the second base station 5-2 (or based on new AI/ML information obtained at the second base station 5-2). In step S1602 the second base station 5-2 transmits the AI/ML information to the first base station 5-1 in the AI/ML information update.

### Distributed AI/ML Architecture

Whilst the network may include a primary node/function that hosts the AI/ML model and generates the AI/ML model inferences, alternatively the AI/ML model may be distributed amongst various nodes in the network. For example, a plurality of base stations 5 may host the AI/ML model and generate inferences. Whilst this may increase the processing required at some network nodes, when the AI/ML model is distributed amongst the network nodes there is a reduction in the number of inferences that are transmitted between the nodes.

When the AI/ML model (or a plurality of AI/ML models—the same model need not necessarily be used at each node) is provided at a plurality of base stations 5, the feedback information can still be provided to each of the base stations that generates inferences using the AI/ML model (for example, to verify the accuracy of the model, as described above).

### Configuration Information for AI/ML

Configuration information for an AI/ML model (which may be referred to as “AI/ML configuration information”) may be exchanged between nodes in the communication network. For example, a core network node may transmit AI/ML configuration information to a base station 5 that hosts an AI/ML model. The AI/ML configuration information may include a list of supported use cases for the AI/ML model (the AI/ML model need not necessarily be for predicting UE mobility). The supported use cases may be, for example: energy saving; traffic steering; anomaly detection; quality of experience (QoE) optimisation; mobility robustness optimisation (MRO); RAN slice service level agreement (SLA) assurance; massive multiple-input multiple-output (MIMO) beamforming optimisation; network slice subnet instance (NSSI) resource allocation; optimisation coverage and capacity optimisation (CCO); mobility load balancing (MLB); RACH optimisation; or UE transmission power optimisation. The AI/ML configuration information may include an indication of a particular AI/ML model to use for a particular use case. The AI/ML configuration information may also include an indication of whether feedback is required (e.g. from another network node). The feedback may include, for example, communication performance feedback (e.g. indicating a communication performance for communication between a UE 3 and a base station 5).

When a plurality of AI/ML models are stored at a UE 3 (or base station 5, or other network node), the UE 3 may receive an indication of which of the AI/ML models to use. The UE 3 may receive (e.g. from a base station 5) an indication that use of a particular model is to be activated or deactivated (e.g. in response to a determination in the performance monitoring step of FIG. 9—a particular AI/ML model may be deactivated if the prediction accuracy has fallen below an acceptable accuracy threshold). The UE 3 may be provided with a plurality of AI/ML models, wherein each model is for use in a particular scenario or configuration.

### Single-Sided and Two-Sided Models

An AI/ML model may be hosted (stored, for generating inferences) at both a base station 5 and a UE 3, may be hosted at only the base station 5, or may be hosted at only the UE 3. When the AI/ML model is used at the UE 3 only, the AI/ML model may be referred to as a ‘single-sided’ model. For example, the UE 3 may host an AI/ML model for generating a time (e.g. time resource) for communication using a particular beam transmitted by the base station 5. However, even when the model is a single-sided model, it will be appreciated that the model need not necessarily be trained at the UE 3. For example, the model could be trained at the base station 5 or at another node in the network (e.g. core network node/function), and then transmitted to the UE 3 for use at the UE 3. In other words, the AI/ML model may be trained at another network node, and then transferred/deployed to the UE 3.

Alternatively, the AI/ML model may be a ‘two-sided’ model, in which an AI/ML model is hosted at the UE 3, and a corresponding AI/ML model is hosted at the base station 5 (however, the models need not necessarily be hosted at a UE 3 and a base station 5—any other suitable two network nodes could alternatively be used). The AI/ML model hosted at the UE 3 and the AI/ML model hosted at the base station 5 may be the same AI/ML model (but need not necessarily be the same model). The UE 3 can use the AI/ML model to generate a first inference, and the base station 5 can use the AI/ML model to generate a corresponding second inference. For example, the first inference may be an inference of a parameter to use for encoding or compressing data (e.g. channel state information (CSI)) to be transmitted from the UE 3 to the base station 5, and the second inference may be an inference of a parameter to use to decode or decompress the data at the base station 5. As with the single-sided model case, the two-sided model (or models) may be trained at any suitable network node, and then transmitted to the UE 3 and the base station 5.

### AI/ML Model Acquisition

Methods of AI/ML model deployment will now be described. In this example, the AI/ML model is transmitted to a UE 3, for use at the UE 3. The AI/ML model may be a two-sided model (in a case where a corresponding AI/ML model, or the same AI/ML model, is used at the base station 5), but could alternatively be an AI/ML model that is used at only the UE 3.

In this example, a broadcast transmission or a multicast transmission is used to transmit the AI/ML model to the UE 3 when the UE 3 is in the RRC idle state or the RRC inactive state. A multicast transmission and/or an RRC message (e.g. dedicated RRC message, or another new RRC message that is different from a legacy RRC message) is used to transmit the AI/ML model to the UE 3 when the UE 3 is in the RRC connected state.

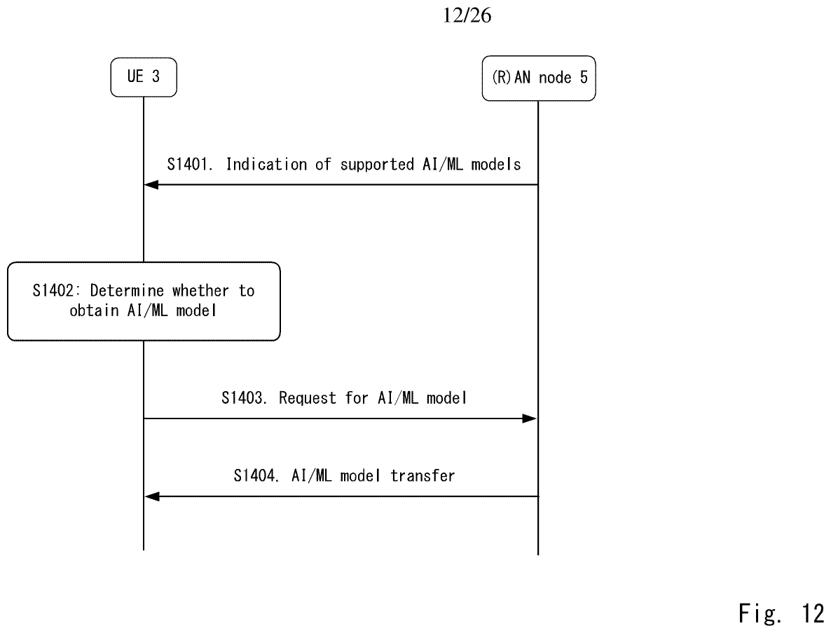

FIG. 12 shows an example of a method in which the base station 5 broadcasts an indication of supported AI/ML models.

In step S1401, the base station 5 broadcasts an indication of supported AI/ML models. In this example, the indication of the supported AI/ML models is included in system information (SI) that is broadcast in a cell of the base station. The UE 3 in this example is in the RRC idle or RRC inactive state (but could alternatively be in the RRC connected state). Advantageously, therefore, the UE 3 is able to receive the information indicating which AI/ML models are supported by the base station 5, even when the UE 3 is in the RRC idle or RRC inactive state.

The broadcast SI may include a list of AI/ML model IDs and/or version numbers for the supported AI/ML models. The supported AI/ML models may be indicated per use case. For example, a first indication of the AI/ML models supported for beam management may be provided, and a second indication of the AI/ML models supported encoding/decoding CSI may also be provided. The indication of the supported AI/ML models may be broadcast periodically by the base station 5, or alternatively could be broadcast in an on-demand manner in response to a request from the UE 3. In addition, the broadcast SI may include an indication of a method for acquiring the AI/ML model (e.g., signalling-based transmission between the UE 3 and the base station 5, or data-based transmission between the UE 3 and an AI/ML server 151). In a case where the UE 3 is to acquire the AI/ML model from an AI/ML server 151, the identity and (IP) address of the AI/ML server 151 can also be included in the SI. Whilst in this example the indication of step S1401 is broadcast by the base station 5, the indication could alternatively be transmitted to the UE 3 in a multicast transmission.

In step S1402 the UE 3 determines, based on the indication of the supported AI/ML models received from the base station 5, whether to obtain one of the supported AI/ML models. In this example, the UE 3 determines to obtain one of the models, and transmits a request for the model to the base station 5 in step S1403. Step S1403 may be performed when the UE 3 is in the RRC idle or RRC inactive state (or, as described in more detail below, as part of a transition from the RRC idle or RRC inactive state to the RRC connected state, e.g. using MSG3). In step S1404 the base station 5 transmits the requested model to the UE 3. As described in more detail below, the UE 3 may be in the RRC connected, RRC inactive or RRC idle state when receiving the AI/ML model from the base station in step S1404.

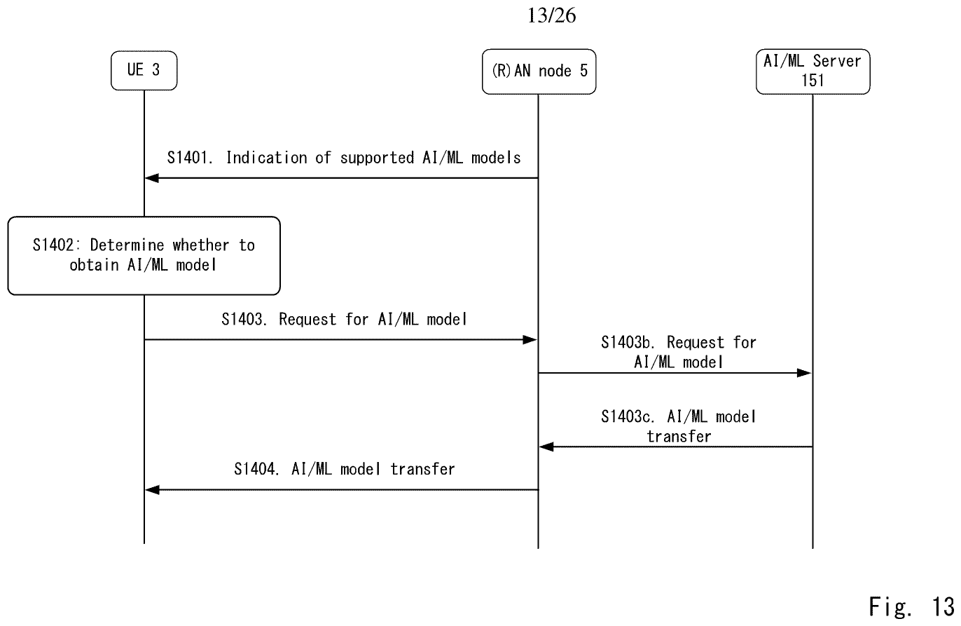

Whilst in the example of FIG. 12 the UE 3 transmits the request for the AI/ML model to the base station 5, and receives the requested AI/ML model from the base station 5, this need not necessarily be the case. The UE 3 may alternatively request and receive the AI/ML model from any other suitable node in the network (e.g. another base station 5, or a core network node/function/server) after receiving an indication of the supported AI/ML models. For example, FIG. 13 shows a modified version of FIG. 12 in which the UE 3 requests an AI/ML model that is stored at an AI/ML server 151. FIG. 13 includes new steps S1403b and S1403c. In step S1403b, the base station 5 transmits, to the AI/ML server 151, a request for the AI/ML model requested by the UE 3. In step S1403c, the AI/ML server 151 transmits the requested model to the base station 5, for forwarding to the UE 3 in step S1404. The forwarding of the AI/ML model via the base station 5 of steps S1403c and S1404 may be transparent to the base station 5 (e.g. the AI/ML model could be transmitted using one or more transparent containers). In a further alternative, the UE 3 may obtain the AI/ML model from the AI/ML server 151 via an AMF 10-1, for example using NAS based signalling. For example, rather than transmitting the request for the AI/ML model to the base station 5, the UE 3 could transmit the request for the AI/ML model to the AMF 10-1. The AMF 10-1 could then request the model from the AI/ML server 151, and forward the AI/ML model from the AI/ML server 151 to the UE 3. In another alternative, the UE 3 could request the AI/ML model from the base station 5, which could then request the AI/ML model from the AI/ML server 151. However, rather than transmitting the AI/ML model to the UE 3 via the base station that received the request, the AI/ML model could be transmitted to the UE 3 via the AMF 10-1 (using corresponding NAS signalling).

When the UE 3 requests an AI/ML model that is stored at the AI/ML server 151, the UE's 3 acquisition of the AIML model from the AI/ML server 151 may be transparent to the radio network from a signalling perspective, since the AI/ML model transfer from the AI/ML server 151 to the UE 3 can be normal data transmission, or the like. However, when the UE 3 establishes an RRC connection with the radio network for such data transmission, it may include the RRC establishment cause (e.g., for AI/ML model transfer) and/or the AI/ML server address in the RRC message. The base station 5 may forward the information to the core network. Beneficially, the information helps the base station 5 and/or the core network node to establish the subsequent user plane data tunnel for AI/ML model transmission between the AI/ML server 151 and the UE 3.

The determination of whether to obtain an AI/ML model in step S1402 may be based on a comparison of an AI/ML model stored at the UE 3 and the supported AI/ML models. For example, the base station 5 may provide an indication of model versions of the supported AI/ML models in the information broadcast in step S1401, and the UE 3 may compare a version number of a model stored at the UE 3 to a version number of one of the supported models and determine that a newer version of a model is to be obtained. Alternatively, the UE 3 may determine that the UE 3 does not store an AI/ML model for a particular use case (e.g. for encoding CSI), and therefore determine to obtain the supported AI/ML model for that use case. Additionally, or alternatively, the UE 3 may determine to transmit the request for the AI/ML model based on a timer. The use of a timer UE 3 enables the UE 3 to request a more recent version of the AI/ML model, even if the UE 3 has not received the indication of the supported AI/ML models of step S1401 (for example, the UE 3 may transmit a request for the most recent version of an AI/ML model stored at the UE 3 to the base station 5 based on the timer, irrespective of whether the UE 3 has received the transmission of step S1401). In a further alternative, the base station 5 may determine to transmit an updated version of a model to the UE 3 in step S1404 based on a timer. Therefore, the base station 5 is able to provide the UE 3 with a more recent version of the AI/ML model even if the base station 5 has not received a request for the more recent version of the AI/ML model from the UE 3. This can be particularly beneficial for two-sided models, for which the version of the model at the UE 3 (e.g. for encoding CSI) may need to match, or correspond to, the version of a model at the base station 5 (e.g. for decoding CSI). By transmitting the request for the AI/ML model in step S1403 or the transfer of the model in step S1404 based on a timer, the risk of the model at the UE 3 becoming mismatched with the model at the base station 5 is reduced. It will be appreciated that even when a timer is used for the transmission of S1403, the UE 3 may nevertheless determine to transmit a request for one or more AI/ML modes even if the time has not yet expired (e.g. based on the information received in step S1401, as described above).

The UE 3 may perform a random access procedure to request the AI/ML model from the base station 5 (e.g. the RA procedure described above with reference to FIG. 6). In this example, MSG3 transmitted from the UE 3 to the base station 5 in the RA procedure includes an RRC establishment cause that indicates that the UE 3 is requesting an AI/ML model (e.g. by including an indication of the identity of the requested AI/ML model, or an indication that the UE 3 is to enter the RRC connected state to download an AI/ML model from the base station 5). The UE 3 may use the RA procedure to request the AI/ML model in both the example of FIG. 12 in which the requested AI/ML model is initially stored at the base station 5, or in the method of FIG. 13 in which the AI/ML model is initially stored at the AI/ML server 151 (or any other suitable network node).

Whilst the use of MSG3 and the RRC establishment cause provides an efficient mechanism for indicating that the UE 3 is requesting an AI/ML model, the indication could alternatively be provided in any other suitable transmission from the UE 3 to the base station 5. For example, the UE 3 may use a new RRC message (e.g. dedicated RRC message) to indicate that the UE 3 is requesting an AI/ML model. Any other suitable method of obtaining the AI/ML model could alternatively be used—the UE 3 need not necessarily use the RA procedure to obtain the model.

In a further alternative, rather than the UE 3 requesting the AI/ML model (entering the RRC connected state to receive the model) in response to the determination of step S1402, the UE 3 may simply wait until the UE 3 is next in the RRC connected state before obtaining the AI/ML model from the base station 5. In another alternative, the UE 3 may receive the AI/ML model when the UE 3 is in the RRC idle or RRC inactive state, rather than entering the RRC connected state to receive the AI/ML model. In this case, the base station 5 transmits an indication of the communication resources (e.g. time and frequency resources) for use by the UE 3 to receive the AI/ML model whilst the UE 3 is in the RRC idle or RRC inactive state.

The AI/ML model may be transmitted from the base station 5 to the UE 3 in step S1404 using an RRC message or a user plane transmission (e.g. using a data radio bearer (DRB)). Advantageously, a priority (e.g. transmission priority) can be assigned for the DRB or logical channel that carries the AI/ML model. As described above, a logical channel may be assigned (e.g. by the base station 5) an index that indicates a priority for transmission of the logical channel, and/or a prioritised bit rate (PBR). The priority or PBR configured for the DRB or LCH that carries the AI/ML model may depend, for example, on the type of AI/ML model that is requested (e.g. the use case of the AI/ML). For example, the DRB or LCH used to transmit an AI/ML model for use as part of a handover procedure could be assigned a higher priority (or higher PBR) than if the AI/ML model were for use in a beam prediction procedure.

From an air interface perspective, when AIML model transfer is subject to user plane transmission as described above, it may be different from conventional user plane (UP) transmission. Conventional UP transmission requires two, or multiple, portions-based transmission (an air interface plus backhaul-based fixed network), e.g. DRB over the air interface plus a data tunnel established between the base station 5 and a UPF in the core network that bridges the data towards a data server. In this conventional method of UP transmission, the base station 5 is not the producer of the data, and instead it is a ‘consumer’ of the data, since the base station simply converts the one or more QoS flows into DRB at the SDAP layer, to support the data transmission for a particular QoS service in terms of data radio bearer over air interface. However, this traditional UP transmission can advantageously be modified: the base station 5 can be the data producer, in a case where the base station 5 itself holds the AIML model, ready for transfer to the UE. When the base station 5 determines to transfer the AI/ML model to the UE 3 via a UP based channel, the base station 5 can configure the data content of AI/ML model as a Service Data Unit (SDU) to the PDCP layer, which can be viewed as a special Data Radio Bearer. In this case, the data of the AI/ML model will not be carried by the SDAP layer, in contrast to the conventional method.

Step S1404 of FIGS. 12 and 13 may comprise transmitting the AI/ML model to the UE 3 using a dedicated radio bearer (e.g. a bearer other than a legacy SRB/DRB). A new logical channel (e.g. dedicated logical channel) could be used to transmit the AI/ML model. The logical channel could be assigned a priority and/or PBR as described above, or alternatively the logical channel may simply not be multiplexed with other logical channels and instead could be transmitted separately.

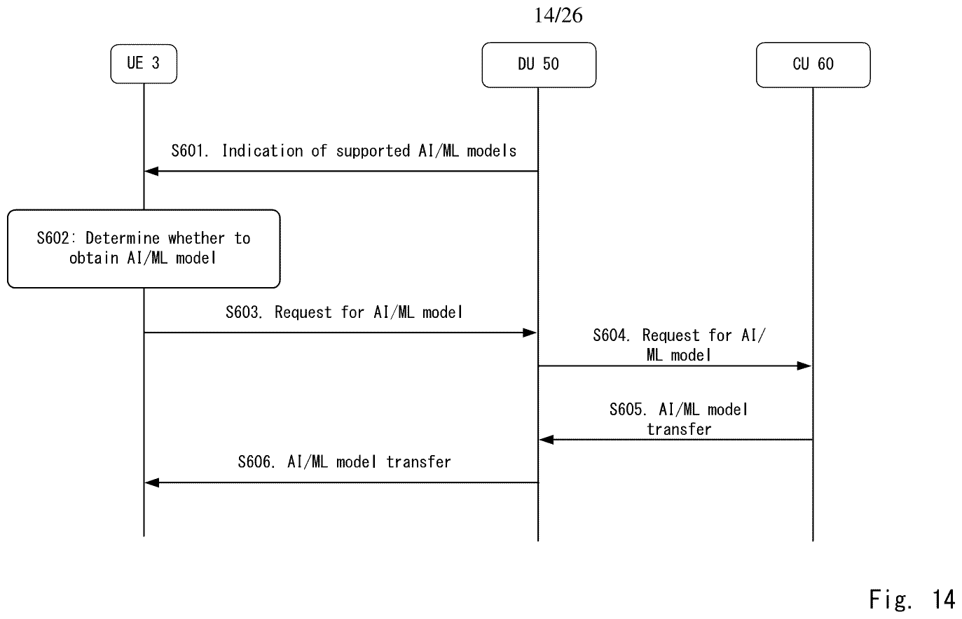

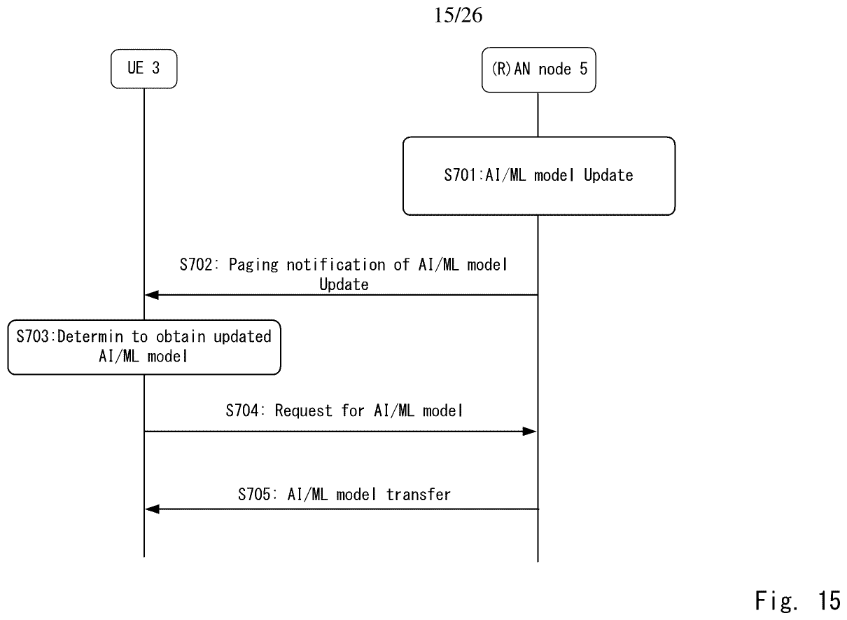

FIG. 14 shows an example of how the requested AI/ML model can be obtained by the UE 3 when the requested AI/ML model is initially stored at a CU 60 of a distributed base station. Steps S601 to S603 are the same as steps S1401 to S1403 described above, and so will not be described again here. In step S604 the DU 50 transmits a request for the AI/ML model requested by the UE 3 to the CU 60, and in step S605 the CU 60 transmits the AI/ML model to the DU 50. Step S606, in which the DU 50 transmits the requested AI/ML model to the UE 3, is the same as step S1404 of FIGS. 14 and 15.

A new (e.g. dedicated) F1-application protocol (AP) message or procedure can be used to transmit the AI/ML model from the CU 60 to the DU 50 in step S605. Moreover, The CU 60 could also transmit, to the DU 50, an indication of the supported AI/ML models to be broadcast by the DU 50 in step S601. The indication of the supported AI/ML models (e.g. model IDs) could be transmitted from the CU 60 to the DU 50 using an F1-AP message (e.g. a dedicated F1-AP message). The DU 50 is therefore able to determine the indication of the supported AI/ML models to be broadcast in step S601.

As described above, the indication of the supported AI/ML models may be transmitted in step S1401 (or step S601) using system information broadcast in a cell of the base station 5. A new SIB could be used to transmit the indication of the supported AI/ML models. This SIB may be referred to as an ‘AI/ML SIB’. SIB1 could be used to provide an indication that the AI/ML SIB is available for broadcast in the cell (the AI/ML SIB may be on-demand SI, that is transmitted in response to a request from the UE 3 that is not shown in FIG. 12 but is transmitted by the UE 3 before step S1401). The MIB and SIB1 may provide the UE 3 with an indication of scheduling information for receiving and decoding the dedicated AI/ML SIB. The AI/ML SIB may include the model IDs of the supported (or ‘available’) AI/ML models. As described above, the AI/ML SIB may indicate the supported AI/ML mods per use case.

The AI/ML SIB may be broadcast periodically (e.g. according to a predetermined periodic pattern), or alternatively may be provided ‘on-demand’, for example in response to the request from a UE 3. SIB1 can be used to indicate to the UE 3 whether the AI/ML SIB is transmitted periodically or whether it is available on-demand.

When the AI/ML SIB is available in an on-demand manner, the base station 5 provides an indication of the availability of the AI/ML SIB, or information indicating the supported AI/ML model IDs for a particular feature (e.g., beam management) in the system information SIB1. The UE 3 may be configured to request the AI/ML SIB using message 1 (MSG1), which may be referred to as a MSG1-based on-demand SI request for the AI/ML SIB, or message 3 (MSG3), which may be referred to as a MSG3-based on-demand SI request for the AI/ML SIB. The UE 3 may also use another type of uplink message to indicate that the UE 3 is requesting information regarding the one or more AI/ML models supported by the base station (e.g., AI/ML model IDs). When the network receives the UE's 3 request for the information (e.g., AI/ML IDs), the network broadcasts the supported AI/ML information (e.g. AI/ML model IDs) for the one or more features as requested by the UE 3 (e.g. using a system information block, AI/ML SIB). The UE 3 can then acquire the AI/ML information by receiving and decoding the broadcasted message (e.g. the AI/ML SIB).

In the examples described above with reference to FIGS. 12 to 14, the UE 3 may request a single AI/ML model, or alternatively could request a plurality of AI/ML models in step S1403 (or step S603).

FIG. 15 shows a modification of the method of FIG. 12, in which the network is configured to use a paging transmission to notify one or more UEs 3 of an update to an AI/ML model.

In step S701 the base station 5 obtains an updated AI/ML model. The updated AI/ML model may be generated at the base station 5, or the updated AI/ML model may be received from another node in the network (e.g. from the AI/ML server 151, or a core network node/function). In step S702 the base station transmits a paging transmission that includes an indication that the AI/ML model has been updated. The paging transmission may be a group paging transmission (a paging transmission intended for reception by a particular group of UEs 3).

The paging transmission of step S702 may include an indication of where the UE 3 is to obtain the updated AI/ML model. For example, if the updated AI/ML model is stored at the AI/ML server 151, then the paging transmission may provide an indication that the UE 3 is to obtain the updated AI/ML model directly from the AI/ML server 151 (or from any other suitable network node). The paging transmission may also include an indication of the UEs 3 that are to obtain the updated AI/ML model (e.g. an indication of the identity of the UEs 3 that are to obtain the updated AI/ML model).

The paging transmission may include an indication that the paging is for notification of an updated AI/ML model. For example, the paging transmission may include a cause value that indicates that the paging is for notification of an updated AI/ML model. The paging transmission may include an indication of the identity of the updated AI/ML model (e.g. model ID number), and/or a version number of the updated AI/ML model.

In step S703 the UE 3 determines to obtain the updated AI/ML model based on the information received in step S702. For example, the UE 3 may determine to obtain the updated AI/ML model based on a difference between a version number of the model stored at the UE 3 and a version number of the updated AI/ML model. Alternatively, the UE 3 may determine to obtain the updated AI/ML model based on an explicit indication in the paging transmission of step S702 that the UE 3 is to obtain the updated AI/ML model. Steps S704 and S705 are the same as steps S1403 and S1404 described above with reference to FIG. 14, and so will not be described again here.

Whilst in this example the paging transmission is used to notify one or more UEs 3 that the AI/ML model has been updated, alternatively (or additionally) the paging transmission could be used to request an identity of an AI/ML model stored at the UE 3, in which case the UE 3 transmits an indication of the AI/ML model stored at the UE 3 to the base station 5 after receiving the request. Alternatively, or additionally, the paging transmission could be used to request AI/ML model history information, or other information regarding the status of the AI/ML model, from the UE 3 (e.g. execution history for the model), in which case the UE 3 transmits the AI/ML model history information to the base station 5 after receiving the request.

### Area-Based AI/ML Models

Methods related to area-based AI/ML models will now be described. An AI/ML model may be for use in a particular area or location. An AI/ML model may be for use in a particular cell or group of cells, which may be operated by one or multiple base stations 5. For example, an AI/ML model may be for use in a group of cells for beam management.

The area in which an AI/ML model is to be used may comprise one or more cells, one or more RAN-based notification areas (RNAs), or registration areas (RAs). However, it will be appreciated that any other suitable area for use of the AI/ML model could be defined. The area within which the AI/ML model is to be used for a particular function (e.g. beam management, CSI encoding/decoding, or mobility) may be referred to as an AI/ML model function area.

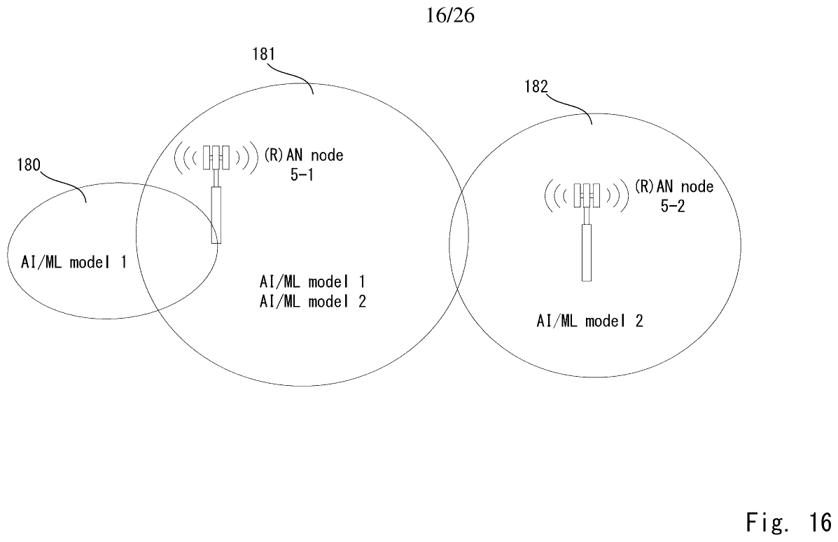

A cell provided by a base station 5 may be part of a plurality of AI/ML model function areas. FIG. 16 shows an example in which a first base station 5-1 provides a first cell 180 and a second cell 181, and a second base station 5-2 provides a third cell 182. In this example, a first AI/ML model is for use in the first cell 180 and the second cell 181 for a first function (e.g. beam management). The AI/ML model function area of the first AI/ML model therefore comprises the first cell 180 and the second cell 181. A second AI/ML model is for use in the second cell 181 and the third cell 182 for a second function (e.g. for CSI encoding/decoding). The AI/ML model function area of the second AI/ML model therefore comprises the second cell 181 and the third cell 182.

In this example, the second cell 181 belongs to both the AI/ML model function area of the first AI/ML model and the AI/ML model function area of the second AI/ML model. In this example, one AI/ML model is used for use for each function in each area. Alternatively, more than one AI/ML model may be available for use for a function in a particular area (e.g. more than one AI/ML model may be available for UE mobility inferences in a particular cell).

In this example, the base station 5 is configured to transmit a broadcast transmission in the first cell 180 that indicates that the first cell 180 belongs to the AI/ML model function area of the first AI/ML model, and to transmit a broadcast transmission in the second cell 181 that indicates that the second cell belongs to the both the AI/ML model function area of the first AI/ML model and the AI/ML model function area of the second AI/ML model. The indication of which AI/ML model function areas the cell belongs to may be referred to as AI/ML model area information. Therefore, a UE 3 in a cell of the base station 5 is able to determine which AI/ML model to use for a particular function in that cell. The base station 5 may be configured to indicate, in the broadcast transmission, the model function areas to which the cell belongs per AI/ML model, or per function. For example, the base station 5 may support two AI/ML features/functions, with AI/ML model X used for the first function, and AI/ML model Y used for the second function. From a network deployment perspective, AI/ML model X for the first function can belong to Area N (which could be, for example, a relatively small area), and AI/ML model Y for the second feature could belong to Area M (which could be, for example, a relatively large area). The broadcast information could indicate that the cell supports AI/ML models X and Y, could indicate that the cell supports the first function with AI/ML model X and the second function with AI/ML model Y, or alternatively could indicate that the cell is part of the corresponding areas N and M (for different models or functions).

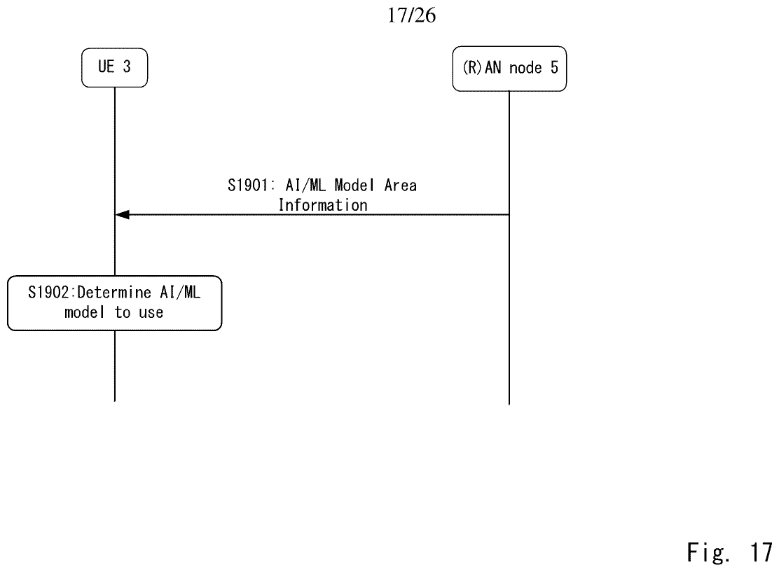

FIG. 17 illustrates a method in which the AI/ML model area information is received by a UE 3. In step S1901 the base station 5 transmits (broadcasts) the AI/ML model area information in a cell of the base station 5, and the information is received by a UE 3 in the cell.

In step S1902 the UE 3 determines, based on the AI/ML model area information, to use a particular AI/ML model. For example, when the UE 3 is in the second cell 181 of FIG. 16 and receives AI/ML model area information that the first AI/ML model is for use for the first function in the second cell 181, the UE 3 determines to use the first AI/ML model for the first function in the second cell 181. If the UE 3 does not support an AI/ML model indicated in the AI/ML model area information, then the UE 3 may simply ignore the AI/ML model area information. After the UE 3 determines to use a particular AI/ML model, the UE 3 may obtain the AI/ML model (if it is not already stored at the UE 3) according to any of the methods described herein (e.g. any of the methods illustrated in FIGS. 12 to 15). For example, the UE 3 may use a random access procedure including MSG3 as part of a method for obtaining the AI/ML model, as described above. As described above, the UE 3 may obtain the AI/ML model either directly from the base station 5, or from another node in the network (e.g. from an AI/ML server 151 (via an AMF 10-1), from an operations, administration, and maintenance server (OAM), or from any other suitable node/function in the network).

Alternatively, rather than the AI/ML model area information including an indication of which AI/ML model is supported for a particular function, the AI/ML model area information may simply include an indication that a particular function is supported in the area. In this case, after receiving the AI/ML model area information, the UE 3 may determine to obtain system information broadcast in the cell to determine which AI/ML model to use. For example, as described above, the UE 3 may request an on-demand SIB that includes an indication of the AI/ML models that are supported for particular functions in the cell. The UE 3 may determine to obtain the AI/ML model after moving into a new cell and receiving the broadcast transmission of step S1901 (e.g. following a cell reselection procedure), or if the AI/ML for use for a particular function in the cell is changed (which the UE 3 can also identify based on the broadcast transmission of step S1901). The UE 3 may be configured to periodically check for transmission of the AI/ML model area information by the base station 5 (e.g. by receiving and decoding the corresponding SI) based on a timer. Similarly, the base station 5 may be configured to periodically broadcast the AI/ML model area information in one or more cells based on a timer.

If the AI/ML model supported for use for a function in a particular area is updated, then the UE 3 may obtain the updated model using any of the methods described above (e.g. the method described with reference to FIG. 15).

The UE 3 may store a plurality of AI/ML models that could be used for a particular function, and the UE 3 may select one of the plurality of AI/ML models based on the AI/ML model area information received in step S1901. For example, the UE 3 may store a first AI/ML model for beam management in a first area, and a second AI/ML model for beam management in a second area, and may determine to use the first AI/ML model based on an indication, in the AI/ML model area information, that the cell belongs to the first area. If the cell belongs to both the first area and the second area, then the UE 3 may provide an indication to the network (e.g. to the base station 5) of whether the first AI/ML model or the second AI/ML model is to be used (e.g. which model is preferred by the UE 3). Advantageously, therefore, for two-sided models a mismatch between the model used at the base station 5 and the model used at the UE 3 can be avoided when a plurality of models are supported for the same function in a particular area. The UE 3 may provide an indication of which AI/ML model is to be used (or which AI/ML is preferred for use) using the first RRC message transmitted to the base station 5 after the UE 3. The UE 3 may include the indication in MSG3 described above with reference to FIG. 6.

In the example of FIG. 16, mobility of the UE 3 may occur from the second cell 181 to the third cell 182. Whilst in the second cell 181, the UE 3 uses the first AI/ML model for the first function. However, in this example the third cell 182 does not support the first function. Therefore, the UE 3 may determine not to use (or to disable) the first AI/ML model for the first function after the UE 3 has moved into the second cell 181. For example, the UE 3 may determine to not use (or to disable) the first AI/ML model in response to receiving a broadcast transmission from the second base station 5-2 that indicates the AI/ML models supported in the third cell 182 (or the AI/ML model function areas to which the third cell 182 belongs). The UE 3 may also determine not to use (or to disable) the first AI/ML model in the third cell 182 even if the UE 3 has not received the broadcast transmission from the second base station 5-2. For example, the UE 3 may determine not to use (or to disable) the first AI/ML model in the third cell 182 as a default option, and only determine to use the first AI/ML model in the third cell if the UE 3 receives an indication that the first AI/ML model can be used in the third cell 182). Advantageously, therefore, use of an unsupported AI/L model or AI/ML model function can be avoided, even when the second base station 5-2 is a legacy base station that may not support transmission of AI/ML related information, such as the transmission of step S1901 of FIG. 17.

### Model Updates and RRC State Transitions

When the UE 3 transitions from the RRC idle state or the RRC inactive state to the RRC connected state, the UE 3 may use layer 1 (L1), layer 2 (L2) or layer 3 (L3) signalling to indicated to the network which AI/ML models are stored at the UE 3 (e.g. by transmitting the associated AI/ML model IDs). The UE 3 may also use the L1/L2/L3 signalling to provide an indication to the network of the versions of the AI/ML models that are stored at the UE 3. The L1/L2/L3 signalling may also be used to provide an indication of history information associated with an AI/ML model (e.g. the execution history of the model).

Based on the L1/L2/L3 signalling, the network (e.g. the base station 5) may determine a particular AI/ML model that is to be used for a particular function. For example, the base station 5 may determine, based on the L1/L2/L3 signalling, that the UE 3 stores an AI/ML model that is also supported at the base station 5, and may therefore determine to use the AI/ML model for a particular function (e.g. beam management, or encoding/decoding of CSI). The base station 5 may determine to transmit the AI/ML model to the UE 3 if it is not already stored at the UE 3, or may determine to transmit, to the UE 3, a different version of an AI/ML model stored at the UE 3. The base station 5 may transmit the AI/ML model to the UE 3 following the transition of the UE 3 to the RRC connected state (e.g. immediately following the transition of the UE 3 to the RRC connected state).

In order to avoid a mismatch between the AI/ML model used at the UE 3 and the AI/ML model used at the base station 5 (for a two-sided AI/ML model), the base station may be configured not to use the AI/ML model until the AI/ML model has been transmitted to the UE 3, or until the base station 5 has received an acknowledgement from the UE 3 that the AI/ML model has been obtained. For example, the base station 5 may use a non-AI/ML algorithm for CSI compression/decompression. The base station 5 may control the activation of use of the AI/ML model at the UE 3 (e.g. for a particular function) using DCI or a medium access control (MAC) control element (CE).

The base station 5 may also receive, in the L1/L2/L3 signalling, information indicating a performance of an AI/ML model used at the UE 3. The model performance information may be the model performance feedback of FIG. 8, or may be information for use in the performance monitoring step of FIG. 9, for example.

When the UE 3 transitions from the RRC connected state to the RRC idle state or the RRC inactive state, the UE 3 may be configured to continue to store one or more AI/ML models that are stored at the UE 3. The UE 3 may be configured to continue to store the AI/ML models for a predefined period, for example based on a timer. However, it will be appreciated that the UE 3 may be configured to delete or overwrite an AI/ML model stored in the memory of the UE 3 if the UE 3 receives a further AI/ML model and does not have sufficient memory to store both of the models. When the UE 3 is configured to continue to store one or more AI/ML models after the UE 3 transitions from the RRC connected state to the RRC idle state or the RRC inactive state, it will be appreciated that the AI/ML is not part of the UE context for the RRC connected state, since the UE context for the RRC connected state is removed after the UE transitions out of the RRC connected state to the RRC idle or RRC inactive state.

### RRC Procedures

RRC procedures may be used for AI/ML related queries transmitted between the network and the UE 3 when the UE 3 is in the RRC connected state. For example, the network may request (e.g. via the base station 5), using an RRC message (e.g. a dedicated RRC message, or other non-legacy RRC message), information indicating an identity of one or more AI/ML models stored at the UE 3. The network may request information indicating the identity of one or more AI/ML models, for a particular function or feature, stored at the UE 3. The UE 3 may transmit a corresponding RRC message to the base station 5 that includes the requested information. For example, the UE 3 may transmit an RRC message to the base station 5 that includes an indication of an AI/ML model ID of an AI/ML model stored at the UE 3.

Similarly, the UE 3 may request AI/ML related information from the network (e.g. via the base station 5) using an RRC message (e.g. a dedicated RRC message, or other non-legacy RRC message). For example, the UE 3 may request an identity of an AI/ML model supported by the base station 5 for a particular function, or may request a version number of an AI/ML model available at the base station 5 (e.g. the UE 3 may request the current version number of an AI/ML model, in order to obtain the most recent version of the model). The base station 5 may then transmit a corresponding RRC message to the UE 3 that includes the requested information (e.g. including an indication of an AI/ML model ID of an AI/ML model stored at the base station 5).

### AI/ML Model Transfer

Improved methods for providing a UE 3 with an AI/ML model will now be described.

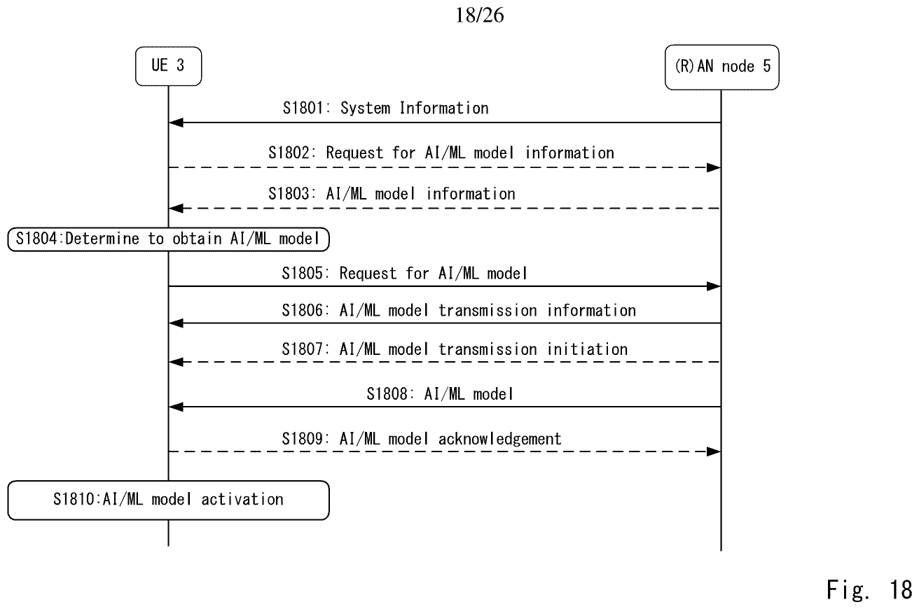

FIG. 18 shows a method in which an AI/ML model is transmitted to a UE 3 by a base station 5.

In step S1801, the base station 5 transmits system information that indicates and AI/ML feature (which may be referred to as a ‘use case’) to be implemented (e.g. activated) at the UE 3. The AI/ML feature may utilise an AI/ML model for, for example, one or more of: energy saving; traffic steering; anomaly detection; quality of experience (QoE) optimisation; mobility robustness optimisation (MRO); RAN slice service level agreement (SLA) assurance; massive multiple-input multiple-output (MIMO) beamforming optimisation; network slice subnet instance (NSSI) resource allocation; optimisation coverage and capacity optimisation (CCO); mobility load balancing (MLB); RACH optimisation; or UE transmission power optimisation. In this example the system information is broadcast by the base station 5 in a cell of the base station 5. However, this need not necessarily be the case. The base station could transmit the indication of the AI/ML feature to be implemented by the UE 3 in any other suitable transmission, such as a multicast transmission. The system information S1801 may be on-demand system information, and may be dedicated system information for indicating the AI/ML feature to be implemented at the UE 3.

The system information transmitted in step S1801 may also include information indicating how the UE 3 can obtain corresponding AI/ML model information. For example, the system information may include an indication of a request message to be transmitted by the UE 3 in order for the UE3 to obtain the AI/ML model information, and corresponding scheduling information. The system information transmitted in step S1801 may also include an indication of information that the UE 3 should include in the request, in order to obtain the AI/ML model information. For example, the system information may include an indication that the UE 3 is to transmit vendor information of the UE 3, or AI/ML capability information of the UE 3 (e.g. AI/ML models or features supported by the UE 3) in the request, in order to obtain the AI/ML model information. Alternatively, the base station 5 may simply transmit the AI/ML model information in the system information transmitted in step S1801 (and could also include an indication of communication resources for use by the UE 3 to obtain an AI/ML model for implementing the AI/ML feature).

In optional step S1802, the UE 3 transmits the request for the AI/ML model information to the base station 5 if the UE 3 has not already received the AI/ML model information from the base station in step S1801. The request for the AI/ML model information may include an indication of model parameters that are supported at the UE 3 (e.g. by indicating a capability of the UE 3), or other information for use by the base station 5 for determining an AI/ML model (and/or corresponding AI/ML model parameters) that is to be transmitted to the UE 3 (e.g. a characteristic of the UE 3 such as a type of the UE 3, a model (e.g. model number) of the UE 3, or a vendor of the UE 3).

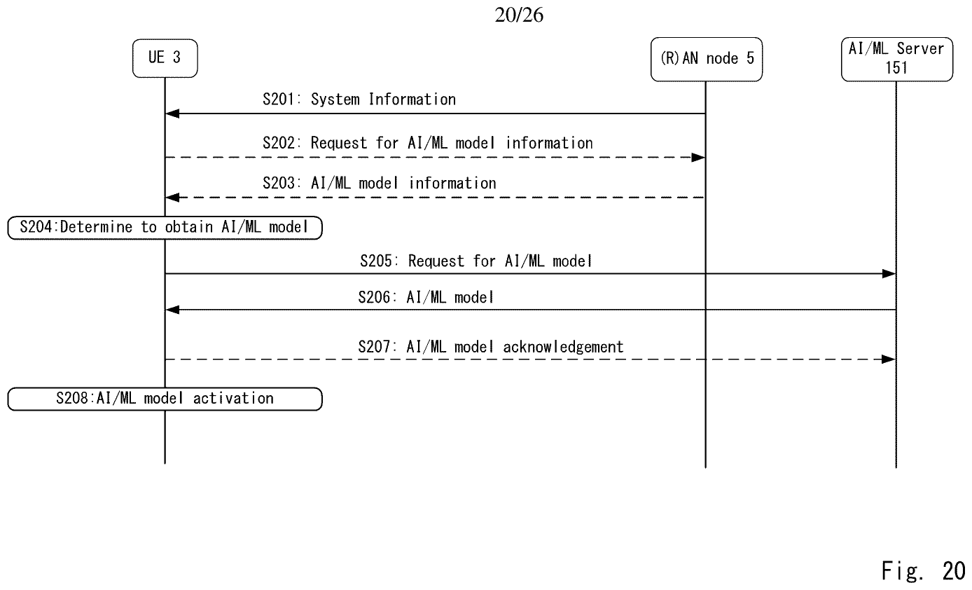

In step S1803, the base station 5 transmits the AI/ML model information to the UE 3. The AI/ML information includes an indication of an AI/ML model to be obtained by the UE 3 (alternatively this information may be provided in step S1801, in which case step S1803 need not necessarily be performed). The transmission of step S1803 may include an indication of an identity of the AI/ML model to be obtained by the UE (e.g. a model ID number), configuration parameters for the AI/ML model, and/or an indication of the size of the AI/ML model (e.g. memory required at the UE 3 in order to store the model). As will be described later with reference to FIG. 20, if the UE 3 is to obtain the AI/ML model from a server 151 or other network node, then the AI/ML model information transmitted in step S1803 also includes information for use by the UE 3 to obtain the model from the server 151 or other network node (e.g. internet protocol, IP, address, or server name).

In step S1804, the UE 3 determines to obtain the AI/ML model based on the information received in step S1803. For example, the UE 3 may determine whether the UE 3 already stores an AI/ML model indicated in the transmission of step S1803, and determine to obtain the model if the UE 3 does not already store the model. Alternatively, for example, the UE 3 may determine to obtain the model if a version of the model indicated in step S1803 is more recent than a version of the model stored at the UE 3.

In step S1805, the UE 3 transmits a request for the AI/ML model. The request for the AI/ML includes an indication of the requested model (e.g. a model ID number of the model, or a version number of the model).

In step S1806, the base station 5 transmits AI/ML model transmission information to the UE 3. The AI/ML model transmission information (which may also be referred to as AI/ML model transfer configuration information) includes an indication of communication resources (e.g. time and/or frequency resources, for example an indication of a configuration of one or more resource blocks) for use in transmitting the AI/ML model to the UE 3. The AI/ML model transmission information may include an indication of a radio bearer configuration for transmission of the AI/ML model from the base station 5 to the UE 3. The radio bearer for transmission of the AI/ML model may be a data radio bearer, DRB, without UPF involvement, or may be a dedicated SRB for transfer of the model. The AI/ML model transmission information may also include scheduling information (in the time and/or frequency domain) for transmission of the model to the UE 3. The scheduling information may include an indication of whether the model transfer is to be performed using the next possible transmission, or after a configured delay (e.g. based on a timer). Alternatively, the AI/ML model transmission may be triggered by a subsequent transmission from the base station (as will be described with reference to optional step S1807). The base station 5 may delay the transmission of the AI/ML model to the UE 3 because, for example, the AI/ML model is also transmitted to one or more other UEs 3 in a multicast transmission, and the other UEs 3 are not yet configured for receiving the multicast transmission.

In optional step S1807, the base station 5 transmits an indication that the model transfer is to be initiated. The transmission of step S1807 may be a multicast transmission or paging transmission (e.g. group paging transmission), for example when the AI/ML model is to be transmitted from the base station 5 to a plurality of UEs 3. The transmission of step S1807 may include an indication of a time resource for use by the base station 5 to transmit the AI/ML model to the UE 3. Alternatively, step S1807 may be omitted, and the method may proceed to step S1808 after step S1806.

In step S1808, the AI/ML model is transmitted from the base station 5 to the UE 3 using the communication resources indicated in step S1806. It will be appreciated that when the base station 5 is a distributed base station, the model may be stored at the CU-UP or CU-CP of the base station 5, and transmitted to the UE 3 via a DU 50 of the base station (and transmitted from the CU-UP or CU-CP to the DU 50 via an F1-U or F1-C interface, respectively).

In optional step S1809, the UE 3 transmits an acknowledgement (ACK) to the base station 5 that indicates that the AI/ML model has been received by the UE 3. If the model has not been successfully received by the UE 3, then UE 3 transmits a negative acknowledgement (NACK) to the base station 5, and the base station 5 may determine to retransmit the AI/ML model to the UE 3. Alternatively, the UE 3 may simply not transmit the ACK to the base station 5 if it has not successfully received the AI/ML model.

In step S1810, the UE 3 activates the received AI/ML model, and can begin using the AI/ML model for the corresponding use case or feature. The UE 3 may determine to activate the model after reception of the model from the base station 5 has been completed. Alternatively, the base station 5 may provide an indication, after the model has been received at the UE 3 (e.g. after the UE 3 has transmitted an ACK in step S1809), that the model is to be activated. Transmitting an indication that the model is to be activated by the base station 5 helps to ensure synchronisation between the model used at the UE 3 and the model used at the base station 5 when a two-sided model is used. Alternatively, the UE 3 could provide an indication to the base station 5 that the UE 3 has activated the AI/ML model.

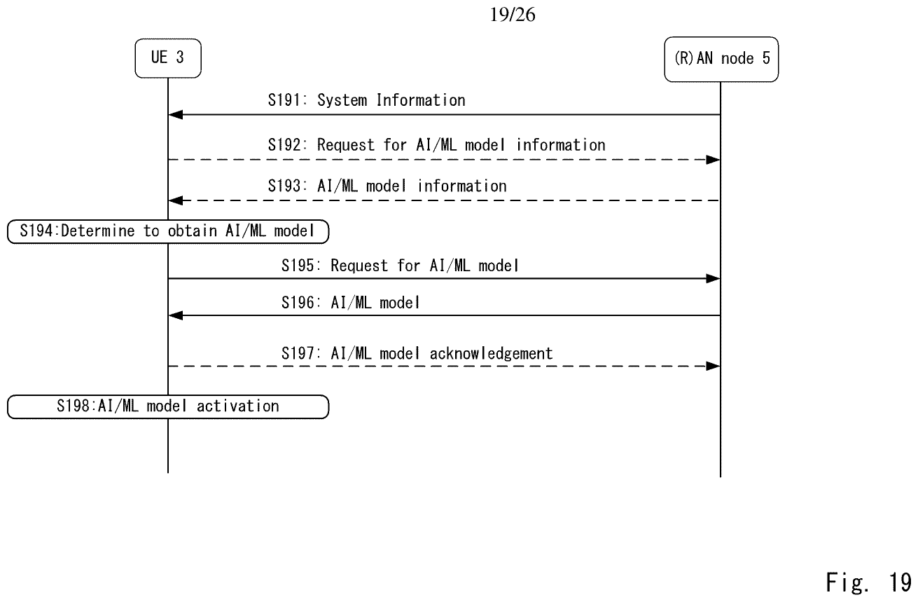

FIG. 19 shows a modification of the example of FIG. 18 in which the AI/ML model is transmitted from the base station 5 to the UE 3 without providing a separate indication of the communication resources for the AI/ML model transmission. In this example, the base station 5 responds with transmission of the AI/ML model in response to the request for the AI/ML model.

Steps S191 to S195 are the same as steps S1801 to S1805, and so will not be described again here.

In step S196, the base station 5 transmits the AI/ML model to the UE 3. The model may be transmitted to the UE 3, for example, using an RRC message, or any other suitable transmission.

Steps S197 and S198 are the same as steps S1809 and S1810, respectively, and so will not be described again here.

FIG. 20 shows a modification of the example of FIG. 18 in which the AI/ML model is transmitted from an AI/ML server 151 to the UE 3.

Steps S201 and S202 correspond to steps S1801 and S1802 of FIG. 18, and so will not be described again here.

Step S203 corresponds to step S1803 of FIG. 18. However, in step S203 the AI/ML model information includes information for use by the UE 3 to obtain the model from the AI/ML server 151 (e.g. internet protocol, IP, address, server name, or configuration information for one or more bearers). Alternatively, this information could be provided to the UE 3 from the base station in step S201, in which case step S203 need not necessarily be performed.

In step S204 is the same as step S1804 of FIG. 18, and so will not be described again here.

In step S205, similar to step S1805 of FIG. 18, the UE 3 transmits a request for the AI/ML model to the AI/ML server 151.

In step S206, the AI/ML model is transmitted from the AI/ML server 151 to the UE 3. The AI/ML model could be transmitted directly from the AI/ML server 151 to the UE 3, or could be transmitted from the AI/ML server 151 to the UE 3 via another network node (e.g. via the base station 5 as illustrated in FIG. 13, or via an AMF 10-1).

In optional step S207, the UE 3 transmits an acknowledgement (ACK) to the AI/ML server 151 that indicates that the AI/ML model has been received by the UE 3. Alternatively, the ACK could be transmitted to the base station, as illustrated in step S1809 of FIG. 18. If the model has not been successfully received by the UE 3, then UE 3 transmits a negative acknowledgement (NACK) to the AI/ML server 151 (or to the base station 5), and the AI/ML model is retransmitted to the UE 3. Alternatively, the UE 3 may simply not transmit the ACK if it has not successfully received the AI/ML model, rather than transmitting a NACK.

Step S208 is the same as step S1810 of FIG. 18, and so will not be described again here.

Whilst in the example of FIG. 20 the model is stored at an AI/ML server 151, and transmitted to the UE 3 from the AI/ML server 151, the network node that stores and transmits the model to the UE 3 need not necessarily be an AI/ML server 151. Alternatively, for example, the network node may be a service management and orchestration (SMO) entity, or a RAN intelligent controller (RIC) (e.g. a non-real time RIC).

In the example of FIG. 20, the AI/ML model could be transmitted from the AI/ML server 151 to the UE 3 using local IP access (LIPA) or selected IP traffic offload (SIPTO). Beneficially, these methods enable the data to be transferred via a local network (e.g. the internet, via a local gateway), rather than via the core network of the communication system 1

Modifications of the examples illustrated in FIGS. 18 to 20 in which the UE 3 transmits an indication of one or more supported AI/ML models or features to the network will now be described.

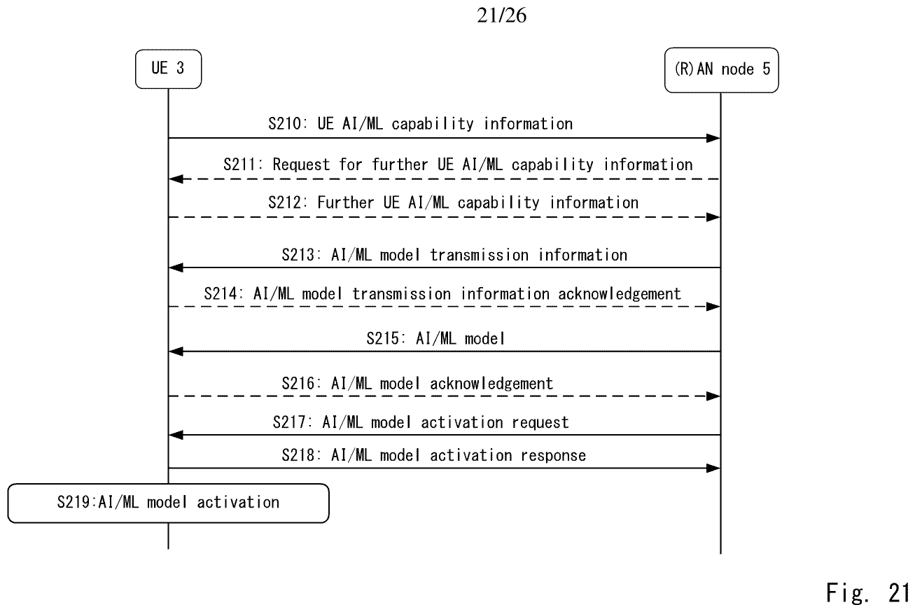

FIG. 21 shows an example in which the UE 3 transmits UE AI/ML capability information to the base station 5 and receives the AI/ML model from the base station. In this example, transmission of the AI/ML model to the UE 3 is network initiated.

In step S210 the UE 3 transmits UE AI/ML capability information to the base station 5. The UE AI/ML capability information indicates an AI/ML capability of the UE 3. For example, the UE AI/ML capability information may include an indication of one or more AI/ML features (or use cases) supported by the UE 3, or an indication of one or more AI/ML models supported or stored by the UE 3 (e.g. an AI/ML model ID, or version number). This method could be used, for example, when the UE 3 stores an AI/ML model, but the base station 5 does not broadcast an indication that the model is supported for use in a cell of the base station 5.

In optional step S211, the base station transmits a request for further UE AI/ML capability information to the UE 3. For example, if not received in step S210, the base station 5 may transmit a request for an indication of AI/ML models supported or stored by the UE 3. In optional step S12, the UE 3 transmits the requested information to the base station 5.

Alternatively, rather than the base station 5 transmitting a request for further UE AI/ML capability information in step S211, the base station 5 may transmit a request for the UE 3 to activate a particular AI/ML model. If the model is available (e.g. stored) at the UE 3, then the UE 3 activates the AI/ML model and transmits a notification to the base station that the AI/ML model has been activated. If the model is not available at the UE 3, or the model is not supported by the UE 3, then the UE 3 may transmit an indication that the AI/ML mode is not stored and/or supported at the UE 3 (e.g. an error message the includes an indication of why the UE 3 cannot activate the AI/ML model as requested by the base station 5, such as a cause value). If the AI/ML model requested, by the base station 5, to be activated is not available at the UE 3, or the model is not supported by the UE 3, then the UE 3 may transmit an indication of one or more AI/ML models that are available for use at the UE 3 to the base station.

After receiving the UE AI/ML capability information in step S210 (and optionally in step S212), the base station 5 determines whether an AI/ML model is to be transmitted to the UE 3. For example, if an AI/ML model is supported by the base station 5 and the UE 3 for a particular feature, but the UE 3 does not currently store the AI/ML model, then the base station 5 may determine that the AI/ML model is to be transmitted to the UE 3. The method then proceeds to step S213, in which the base station transmits AI/ML model transmission information to the UE 3. The AI/ML model transmission information (which may also be referred to as AI/ML model transfer configuration information) includes an indication of communication resources (e.g. time and/or frequency resources, for example an indication of a configuration of one or more resource blocks) for use in transmitting the AI/ML model to the UE 3. The AI/ML model transmission information may include an indication of a radio bearer configuration for transmission of the AI/ML model from the base station 5 to the UE 3. The radio bearer for transmission of the AI/ML model may be a data radio bearer, DRB, without UPF involvement, or may be a dedicated SRB for transfer of the model. The AI/ML model transmission information may also include scheduling information (in the time and/or frequency domain) for transmission of the model to the UE 3.

In optional step S214, the UE 3 transmits an AI/ML model transmission information acknowledgement message to the base station 5, indicating that the UE 3 has received the information transmitted in step S213. For example, if the transmission of step S213 includes an indication of a data radio bearer (DRB) for use by the UE 3 to receive the AI/ML model, then the UE 3 may transmit an indication that the UE 3 has received the configuration for the (DRB), in step S214.

In step S215 the UE 3 receives the AI/ML model from the base station 5, using the communication resources indicated in step S213.

In step S216, the UE 3 transmits an acknowledgement (ACK) to the base station 5 that indicates that the AI/ML model has been received by the UE 3. If the model has not been successfully received by the UE 3, then UE 3 transmits a negative acknowledgement (NACK) to the base station 5, and the base station 5 may determine to retransmit the AI/ML model to the UE 3. Alternatively, the UE 3 may simply not transmit the ACK to the base station 5 if it has not successfully received the AI/ML model.

In step S217 the base station 5 transmits an AI/ML model activation request to the UE 3. The AI/ML model activation request includes an indication that the UE 3 is to activate the AI/ML model transmitted in step S215. Alternatively, the AI/ML model activation request may include an indication that the UE 3 is to activate an AI/ML model other than the AI/ML model transmitted in step S215 (e.g. a model that the UE 3 has indicated is stored at the UE 3, in step S210 or step S212). Whilst in this example the AI/ML model activation request transmitted in step S217 is transmitted separately from the transmission of the AI/ML model itself in step S215, this need not necessarily be the case. Alternatively, the AI/ML model activation request could be transmitted with the AI/ML model in step S215.

In step S218, the UE 3 transmits a corresponding AI/ML model activation response to the base station 5. If the AI/ML model is available for activation at the UE 3 (e.g. because it has been successfully received in step S215), then the UE 3 transmits an indication to the base station 5 that the UE 3 is to activate the AI/ML model. In step S219 the UE activates the AI/ML model. Alternatively, step S219 may be performed before step S218, such that the UE 3 activates the AI/ML model and then transmits an indication to the base station 5 that the AI/ML model has been activated.

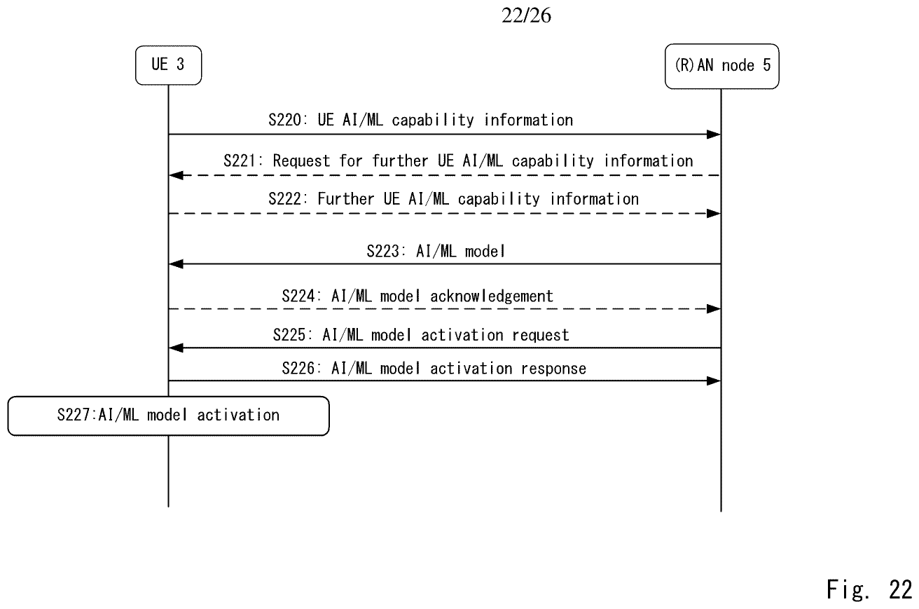

FIG. 22 shows an example in which the UE 3 transmits UE AI/ML capability information to the base station 5, and the AI/ML model is transmitted from the base station to the UE without providing a separate indication of the communication resources for the AI/ML model transmission.

Steps S220 to S222 are the same as steps S210 to S212 of FIG. 21, and so will not be described again here.

In step S223, the base station 5 transmits the AI/ML model to the UE 3. The model may be transmitted to the UE 3, for example, using an RRC message, or any other suitable transmission.

Steps S224 to S227 are the same as steps S216 to S219 of FIG. 21, and so will not be described again here.

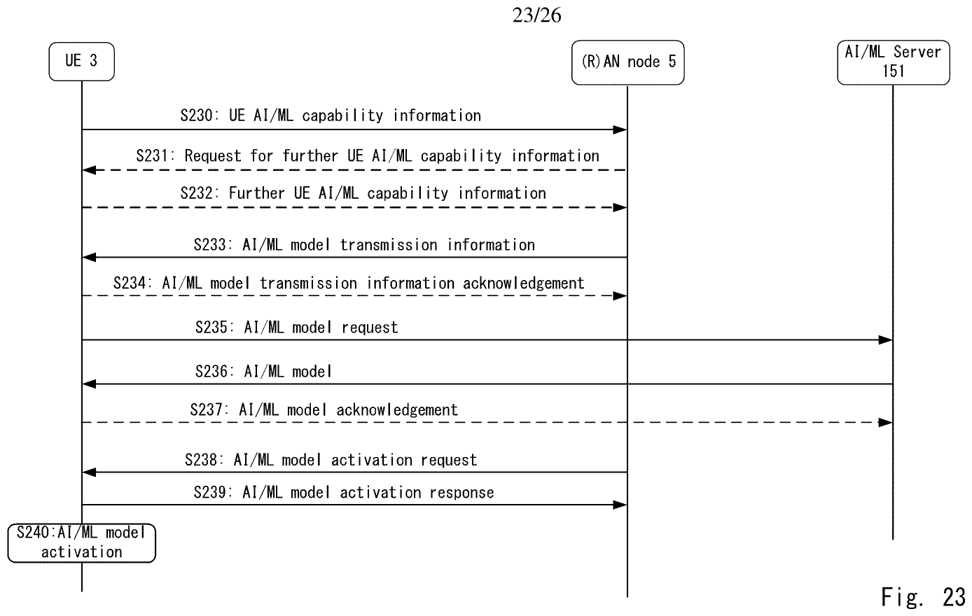

FIG. 23 shows an example in which the UE 3 transmits UE AI/ML capability information to the base station 5, and the AI/ML model is transmitted from an AI/ML server to the UE.

Steps S230 to S232 are the same as steps S210 to S212 of FIG. 21, and so will not be described again here.

In step S233, the base station transmits AI/ML model transmission information to the UE 3. The AI/ML model transmission information includes an indication of information for use by the UE 3 to obtain the model from the AI/ML server 151 (e.g. internet protocol, IP, address, server name, or configuration information for one or more bearers). The AI/ML model transmission information may also include an indication of an AI/ML model that the UE 3 is to obtain from the AI/ML server 151 (e.g. AI/ML model ID number, or version number).

In step S234 the UE 3 transmits a corresponding acknowledgement that the UE 3 has received the AI/ML model transmission information.

In step S235 the UE 3 transmits a request for an AI/ML model to the AI/ML server 151 based on the information received in step S233.

In step S236, the AI/ML model is transmitted from the AI/ML server 151 to the UE 3. The AI/ML model could be transmitted directly from the AI/ML server 151 to the UE 3, or could be transmitted from the AI/ML server 151 to the UE 3 via another network node (e.g. via the base station 5 as illustrated in FIG. 13, or via an AMF 10-1).

In optional step S237, the UE 3 transmits an acknowledgement (ACK) to the AI/ML server 151 that indicates that the AI/ML model has been received by the UE 3. Alternatively, the ACK could be transmitted to the base station, as illustrated in step S1809 of FIG. 18. If the model has not been successfully received by the UE 3, then UE 3 transmits a negative acknowledgement (NACK) to the AI/ML server 151 (or to the base station 5), and the AI/ML model is retransmitted to the UE 3 from the AI/ML server. Alternatively, the UE 3 may simply not transmit the ACK if it has not successfully received the AI/ML model, rather than transmitting a NACK.

Steps S238 to S240 are the same as steps S217 to S219 of FIG. 21, and so will not be described again here.

### Signalling and Model Transmission

Protocols, layers and messages that could be used for the transmissions illustrated in FIGS. 18 to 23 will now be described.

### RRC Layer Signalling and Model Transmission

The RRC layer may be used for any/all of the transmissions illustrated in FIGS. 18 to 23. For example, all of the transmissions in steps S1801 to S1803 and S1805 to S1809 may be RRC transmissions/messages, including transmission of the AI/ML model in step S1808. However, when an RRC transmission is used to transmit the AI/ML model in step S1808, the present inventors have realised that is advantageous to use an RRC message having a larger number of segmentations, since the amount of data required to transmit the AI/ML model is relatively large. RRC segments are described in more detail in 3GPP TS 38.331. The RRC message may be modified to increase the number of allowed segments, or a dedicated procedure could be used to handle the segmentation for the case of AI/ML model transfer. A new (e.g. dedicated) radio bearer may also be used for transfer of the AI/ML model, which advantageously enables improved control by the network of the transmission of the model. For example, a dedicated radio bearer enables improved quality of service (QoS) provision, and improved control of retransmissions (e.g. that takes into account the relatively large data sizes for transmission of the AI/ML model). The PDCP and RLC functionality may also be modified to account for the relatively large data sizes for transmission of the AI/ML model (e.g. by modifying the PDCP segmentation method).

### Dedicated AI/ML Protocol Layer

A new (e.g. dedicated) protocol layer can be used for any/all of the transmissions illustrated in FIGS. 18 to 23. For example, all of the transmissions in steps S1801 to S1803 and S1805 to S1809 may be transmission of a layer dedicated for AI/ML related transmissions, including transmission of the AI/ML model in step S1808.

In other words, a dedicated AI/ML protocol layer may be used for any/all of the transmissions illustrated in FIGS. 18 to 23. Advantageously, use of a dedicated AI/ML protocol layer enables, for example, the AI/ML model to be transmitted more efficiently, by enabling a larger number of message segments, or by providing a dedicated radio bearer configuration.

The RRC layer could be used to set up a radio bearer used for signalling and/or model transfer between the UE 3 and the network for the dedicated AI/ML protocol layer.

### RRC Layer and Dedicated AI/ML Protocol Layer

A combination of the RRC layer and the dedicated AI/ML protocol layer could be used for the transmissions illustrated in FIGS. 18 to 23. For example, the dedicated AI/ML protocol layer could be used for the transmission of the model (e.g. in step S1808), and the RRC layer could be used for all of the remaining transmissions. Advantageously, this provides a more efficient way of transmitting the model itself (e.g. by enabling a larger number of message segments, or by providing a dedicated radio bearer configuration), whilst making use of the RRC layer for the other transmissions.

### RRC Layer and Application Layer

A combination of the RRC layer and the application layer (layer 7, L7) could be used for the transmissions illustrated in FIGS. 18 to 23. For example, the application layer could be used for the transmission of the model (e.g. in step S1808), and the RRC layer could be used for all of the remaining transmissions. Advantageously, this provides a more efficient way of transmitting the AI/ML model, whilst making use of the RRC layer for the other transmissions. The RRC layer may be used to provide assistance information for the model transfer (e.g. the transport address to be used by the application layer for the model transfer, and an indication of which AI/ML model is to be transmitted).

### Protocol Stack

A new (e.g. dedicated) protocol stack could be used for any/all of the transmissions illustrated in FIGS. 18 to 23. The protocol stack may support legacy PDCP, RLC, MAC and PHY functionality, and may support the dedicated protocol layer for transmission of the AI/ML model.

Establishment and release of the protocol stack performed between the UE 3 and the base station 5 may be achieved using a new (e.g. dedicate) RRC message.

In the protocol stack, the PDCP functionality (or PDCP-like functionality) may use an AI/ML model specific security key for model data encryption and decryption. The security key may be a common key, and may apply to each UE 3 that is to receive the AI/ML model.

A data radio bearer may be used for transmission of the AI/ML model, wherein the bearer is terminated at the UE 3 and at the base station 5. Alternatively, the AI/ML mode transmission may be performed between the peer protocol entities (e.g. dedicated AI/ML model transmission protocol layer), in which case the data radio bearer need not be used for transmission of the AI/ML model.

In this example, a resource allocation may be performed (e.g. by the base station 5) for transfer of the AI/ML model, and advantageously therefore the data for the transmission of the AI/ML model need not be multiplexed with other data transmission to the UE 3.

Data segmentation for transmission of the AI/ML model can be performed by the dedicated AI/ML protocol layer, or using PDCP functionality (or PDCP-like functionality, since the AI/ML model size may be larger than the largest available PDCP PDU). A larger PDCP PDU size may be used for transmission of the AI/ML model (e.g. 64 MB, or any other suitable size).

The protocol stack may be released when a connection between the UE 3 and the base station 5 is interrupted, and transmission of the AI/ML model to the UE 3 may not be complete. In this case, the UE 3 may maintain (continue to store) a context associated with the protocol stack, for example until the expiry of a timer. Advantageously, therefore, the UE 3 can use the maintained context for the protocol stack when the UE 3 reconnects to the network (and may transmit the maintained context to the network), even if the UE 3 is connected to a different base station 5 than the base station 5 the UE 3 was connected to when the connection was interrupted (in this case, the new base station 5 may continue the transmission of the AI/ML model if it is available at the new base station 5).

### AI/ML Model Transmission Interruption

Improved methods for handling a scenario in which transmission of the AI/ML model to the UE 3 is interrupted will now be described.

Due to the relatively large amount of data that is transmitted when transmitting the AI/ML model to the UE 3, time required to transmit the AI/ML model to the UE 3 is relatively long. Therefore, there is an increased risk that the transfer is interrupted. Interruption of the transfer may occur, for example, due to radio link failure (RLF), or handover of the UE 3 to another base station 5.

If RLF occurs during transmission of the AI/ML model to the UE 3, then the UE 3 may be configured to discard the segments (or other unit of received data) of the AI/ML model before the RLF, and transfer of the model is restarted after the UE 3 reconnects to the network.

If the UE 3 is communicating with the base station 5 via a cell for transfer of the AI/ML model when the RLF occurs, and communication between the UE 3 and the same base station 5 via the same cell is subsequently restored, then the UE 3 model transfer can be resumed. In this case, the UE 3 may transmit model transmission context information to the base station 5, that indicates a status of the transmission of the AI/ML model. For example, the model transmission context information may include an indication of the number of segments (or any other suitable unit of data) of the AI/ML model received at the UE 3, an indication of the last segment received at the UE 3, or any other suitable information. The base station 5 can advantageously use the transmission context information to configure the transmission of the remaining portion of the AI/ML model to the UE 3. If the UE 3 has connected to a different base station 5, or has connected to the same base station 5 but via a different cell, then the UE may discard (e.g. delete, overwrite, or configure to be overwritable) the segments of the AI/ML model received before the RLF, and transfer of the model is restarted (if the AI/ML model is available for transmission).

If the UE 3 is communicating with the base station 5 via a cell for transfer of the AI/ML model when the RLF occurs, and then connects to the network via a different cell of the base station 5, or via a different base station 5, then the transmission of the model can be resumed if AI/ML model is also available for transmission by the new base station 5, or is available for transmission in the new cell. If the cell via which the UE 3 is communicating has changed following the RLF, then the UE 3 may provide an indication to the network (e.g. base station 5) of the cell that was being used for transmission of the AI/ML model before the RLF. If the new cell is provided by the same base station 5 that provided the original cell, then the base station 5 can determine the status of the AI/ML model transmission (e.g. the last segment, or other unit of data transmission, that was successfully transmitted to the UE 3). If the new cell is provided by a different base station 5 than the base station that provided the original cell, then the new base station 5 may request the status of the AI/ML model transmission from the first base station 5 (e.g. via an Xn interface), and the original base station transmits the requested status to the new base station 5. Advantageously, therefore, the new base station 5 is able to determine the status of the AI/ML model transmission, and resume transmission of the AI/ML model to the UE 3, even following RLF and a change of base station 5.

The UE 3 may be configured to attempt to resume the transfer of the AI/ML model to the UE 3 even when there is a change of cell or base station 5 following the RLF. The UE 3 may transmit an indication to the base station 5 (which may be a different base station than the base station 5 from which the UE 3 was receiving the AI/ML model before the RLF), following the RLF, that transmission of the AI/ML model was interrupted, and an indication of the status of the AI/ML model transmission (e.g. the last segment, or other unit of data transmission, that was successfully transmitted to the UE 3). If the base station 5 or cell has changed following the RLF, and the AI/ML model is not available for transmission (e.g. because the AI/ML model is not stored at the new base station 5), then an indication that the request for resumption of the AI/ML transmission is rejected may be transmitted to the UE 3.

Transmission of the AI/ML model to the UE 3 may be via RRC transmissions or user plane (UP) transmissions. In a case where the AI/ML model is transmitted to the UE 3 using one or more RRC messages, the segments may be RRC segments, each having an associated RRC segment number. The RRC segment number of the last segment received by the UE 3 may be stored by the UE 3 (e.g. in RRC context information). The RRC segment number of the last segment received by the UE 3 may also be stored at the base station 5 (e.g. in RRC context information). Advantageously, when the UE 3 experiences RLF, the UE 3 and the base station 5 can maintain the RRC context information that includes the indication of the last segment received by the UE 3. Therefore, if the RRC connection between the UE 3 and the base station 5 is resumed, the transmission of the AI/ML model can be resumed based on the stored RRC context information. Alternatively, the UE 3 may transmit the segment number of the last received RRC segment (and optionally the AI/ML model ID of the model that was being transmitted) as part of a RLF report during the RRC reestablishment procedure. The base station 5 is then beneficially able to resume the transmission of the AI/ML model based on the indicated segment number.

In a case where the UE 3 is receiving the AI/ML model from the base station 5 via a user plane transmission, the UE 3 may receive the AI/ML model via a DRB established between the base station 5 and the UE 3. In this case, the segments may be PDCP segments having a corresponding PDCP sequence number (SN), or may be generated using a dedicated protocol layer (e.g. the AI/ML protocol layer described above). In the case where the UE 3 is receiving the AI/ML model via a dedicated AI/ML bearer, transmission of the AI/ML model can be resumed following the RLF. For example, a PDCP status report may be transmitted by the UE 3 to the base station 5, that indicates the status of the AI/ML model transmission (e.g. the SN corresponding to the last received data of the AI/ML model transfer). The base station 5 is then beneficially able to resume transmission of the AI/ML model based on the SN.

In a case where transmission of the AI/ML model to the UE 3 is interrupted by handover of the UE 3 from a source base station 5 to a target base station 5 (e.g. as illustrated in FIG. 5), the UE 3 may be configured to discard the segments (or other unit of received data) of the AI/ML model received from the source base station 5, and transfer of the model is restarted after the handover to the target base station 5 is complete.

Alternatively, the source base station may indicate (e.g. in step S505 of FIG. 5) to the UE 3 that transmission of the AI/ML model is to be resumed following the handover. Following the handover, the UE 3 may provide an indication to the target base station 5 of the status of the transmission of the AI/ML model. For example, the UE may transmit an indication of the number of segments (or any other suitable unit of data) of the AI/ML model received at the UE 3, an indication of the last segment received at the UE 3, or any other suitable information, to the target base station 5. In a further alternative, the source base station 5 may already store the number of segments (or any other suitable unit of data) of the AI/ML model transmitted to the UE 3, or an indication of the last segment transmitted to the UE 3 (e.g. in RRC context information), and can simply transmit the information to the target base station (e.g. via an Xn interface), without needed to first receive the information from the UE 3. The source base station 5 may transmit, to the target base station, information indicating the identity of the AI/ML model that was being transmitted. The source base station 5 may also transmit, to the target base station 5, the remaining portion of the AI/ML model to be transmitted to the UE 3. Advantageously, therefore, the target base station 5 is able to transmit the remaining portion of the AI/ML model to the UE 3, even if the AI/ML model was not previously stored at the target base station 5.

Alternatively, if the source base station 5 provides an indication to the UE 3 that transmission of the AI/ML model will not be resumed after handover to the target base station, the UE 3 may simply discard (e.g. delete, or allow to be overwritten) the portion of the AI/ML model received from the source base station 5.

### AI/ML Model Activation and Monitoring

Methods for AI/ML activation and monitoring (e.g. activation tracking) will now be described.

In a case where AI/ML information is broadcast by the network (e.g. the transmissions in step S1401 of FIGS. 12 and 13, step S601 of FIG. 14, of the system information transmitted by the base station in the methods illustrated in FIGS. 18 to 20), the network might not necessarily have information available that indicates whether a UE 3 is using a particular AI/ML model or not.

The network (e.g. base station 5) may perform explicit activation of an AI/ML model at a UE 3. For example, the base station 5 may transmit an AI/ML model activation request to the UE 3, as illustrated for example in step S217 of FIG. 21. This enables the network to achieve relatively strict control of the AI/ML models used by the UE 3 (e.g. if the UE 3 is configured not to activate an AI/ML model for use unless the UE 3 receives the explicit activation indication from the network). This may be particularly beneficial, for example, if an AI/ML has not been operating as expected, and deployment of the model to a relatively small number of UEs 3 is desirable (e.g. to test the model, or to deploy the model only to UEs 3 where it must be deployed). For other AI/ML models, the UE 3 may activate the model for use by default (e.g. after receiving the AI/ML model).

When the base station transmits the information indicating the AI/ML features or AI/ML models for use by UEs 3 in a cell of the base station 5 (e.g. the transmissions in step S1401 of FIGS. 12 and 13, step S601 of FIG. 14, of the system information transmitted by the base station in the methods illustrated in FIGS. 18 to 20), the base station may include an indication of which AI/ML models are to be activated by default by the UE 3, and which AI/ML models require an activation indication to be received by the UE 3 before the UE 3 is to activate the AI/ML model for use.

Alternatively, the base station 5 may be configured to broadcast AI/ML information related to AI/ML models that are to be activated by default by the UE 3, and to transmit information related to AI/ML models (e.g. an indication that the model is available for use) for which activation by the network is required using dedicated signalling (e.g. in step S213 of FIG. 21).

Even for AI/ML models that are activated by default by a UE 3, it may be beneficial for the network to obtain information indicating which UEs 3 are using the model. Therefore, the UE 3 may be configured to transmit an indication to the base station 5 that the UE 3 has activated an AI/ML model, even when the AI/ML model was activated by default by the UE 3 (rather than in response to receiving a request to activate the AI/ML model from the network). The indication that the AI/ML model has been activated at the UE 3 may include an AI/ML model ID, AI/ML model version number, and/or the use case or feature for which the AI/ML model has been activated.

The base station 5 may also be configured to transmit, to the UE 3, a request for information regarding the AI/ML models that the UE 3 is using. The UE 3 then transmits, to the base station 5, after receiving the request, an indication of one or more AI/ML models that the UE 3 is using (if any). The UE 3 may transmit, to the base station 5, an AI/ML model ID, AI/ML model version number, and/or the use case or feature for which the AI/ML model has been activated.

### UE Capability and AI/ML Model Transfer

Further operational considerations for use of AI/ML models in the communication system 1 will now be described.

The state of a UE 3 at a particular time may not be suitable for reception of an AI/ML model by the UE 3, or use of the AI/ML model of the UE 3. For example, the UE 3 may not have sufficient memory or storage to receive or use the AI/ML model, or the UE 3 may have insufficient power or processing resources to run the AI/ML model.

The UE 3 may be configured to transmit an indication to the base station 5 of whether the UE 3 can receive or use (e.g. activate) the AI/ML model. The UE 3 may transmit the indication to the base station 5 after receiving, from the base station, information indicating the AI/ML models that are available for use. The UE 3 may provide an indication, for each AI/ML model indicated by the base station 5, of whether the UE 3 is able to receive (e.g. has sufficient memory to store) and/or use the AI/ML model. The base station 5 is then advantageously able to determine whether an AI/ML model can be transmitted to, or activated at, the UE 3. Alternatively, or additionally, the base station 5 may be configured to transmit, to the UE 3, a request for information indicating whether the UE 3 is able to receive and/or use one or more AI/ML models. Advantageously, for example, when an AI/ML model is stored at the UE 3, the base station 5 is able to determine whether the UE 3 is capable of activating and using the model. In a further alternatively, the UE 3 may be configured not to initiate obtaining of an AI/ML model (e.g. requesting transmission of the AI/ML model by the base station) if the state of the UE 3 would not allow the UE 3 to store and/or use the AI/ML model.

### User Equipment

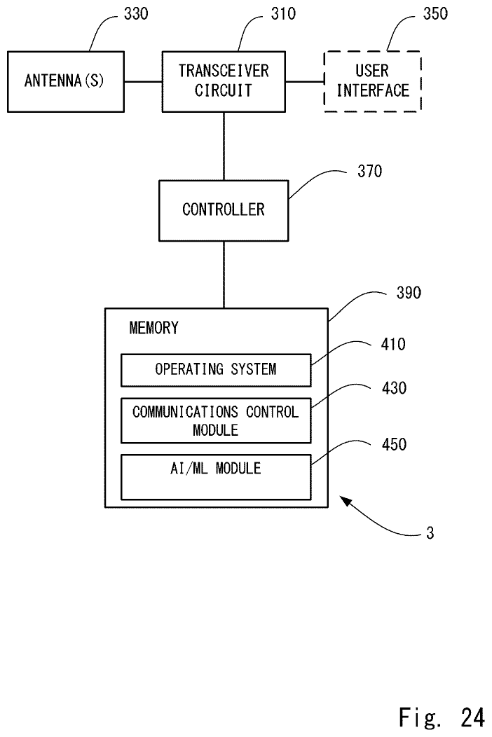

FIG. 24 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the telecommunications network or from a removable data storage device (RMD), for example.

The controller 370 is configured to control overall operation of the UE 3 by, in this example, program instructions or software instructions stored within memory 390. As shown, these software instructions include, among other things, an operating system 410, a communications control module 430, and an AI/ML module 450.

The communications control module 430 is operable to control the communication between the UE 3 and its one or more serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to transmit a measurement report according to any of the methods described above).

The AI/ML module 450 is operable to control the use of an AI/ML model at the UE 3 (e.g. to generate one or more inferences using the model). The AI/ML module 450 may be configured to perform any of the AI/ML related functions of the UE 3 of any of the methods described above.

### Base Station

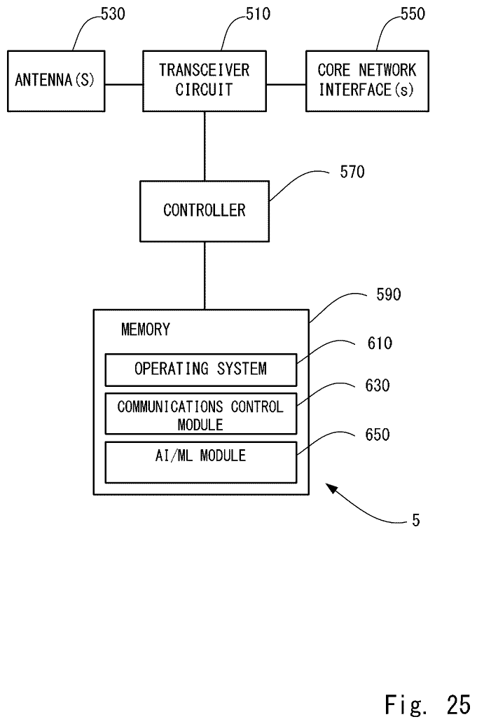

FIG. 25 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antennas 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590.

As shown, these software instructions include, among other things, an operating system 610, a communications control module 630 and an AI/ML module 650.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 630 may be configured to control communications in accordance with any of the methods described above (for example, to receive or transmit UE 3 mobility information, or a handover request).

The AI/ML module 650 may be configured to perform any of the AI/ML related functions of the UE 3 of any of the methods described above. The base station 5 may be configured to train or re-train the AI/ML model as described above (for example, in response to UE mobility information that is fed back to the base station 5 from another node in the network, such as another base station 5).

### Core Network Node/Function

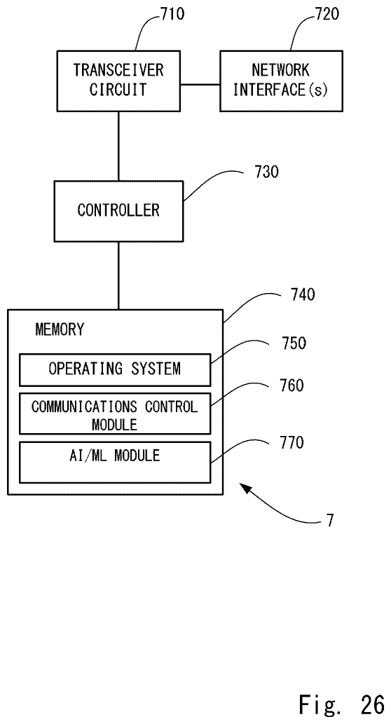

FIG. 26 is a block diagram illustrating the main components of a core network node or function, such as the AMF, CPF, the UPF, the SMF or OAM. As shown, the core network function includes a transceiver circuit 710 which is operable to transmit signals to and to receive signals from other nodes (including the UE 3, the base station 5, and other core network nodes) via a network interface 720. A controller 730 controls the operation of the core network function in accordance with software stored in a memory 740. The software may be pre-installed in the memory 740 and/or may be downloaded via the communication system 1 or from a removable data storage device (RMD), for example. The software includes, among other things, an operating system 750, and a communications control module 760.

The communications control module 760 is responsible for handling (generating/sending/receiving) signalling between the core network function and other nodes, such as the UE 3, the base station 5, and other core network nodes. The signalling may include for example a UE context/UE capability indication of a UE 3 related to energy saving.

As shown in FIG. 21, the core network node/function may also include an AI/ML module 770. If present, the AI/ML module 770 is operable to perform any of the AI/ML related functions of the core network node/function according to any of the methods described above. The core network node/function may be configured for training or re-training the AI/ML model as described above (for example, in response to UE mobility information that is fed back to the core network node/function from another node in the network, such as the base station 5).

### Modifications and Alternatives

As those skilled in the art will appreciate, a number of modifications and alternatives can be made to the above example embodiments whilst still benefiting from the disclosures embodied therein.

Whilst the above examples have been described with reference to an AI/ML model, it will be appreciated that the above described methods are advantageous even when the model is not an AI/ML model. Any other suitable type of model or function may be used to generate inferences (e.g. determinations or predictions).

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and exemplary embodiments are not limited to the above-described UE and various modifications can be made thereto.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by an access network node, the method comprising: transmitting, to a user equipment, UE, an indication of a feature for implementation in a cell of the access network node, wherein the feature is implemented using a corresponding model for generating a determination, prediction, or output parameter;
receiving, from the UE, a request for the model; and
transmitting, to the UE, at least one of:
model transmission information that includes an indication of one or more communication resources for use by the UE to receive the model; or
the model.

### (Supplementary Note 2)

The method according to supplementary note 1, wherein the model is an artificial intelligence or machine learning, AI/ML, model.

### (Supplementary Note 3)

The method according to supplementary note 1 or 2, wherein the method further comprises transmitting, to the UE, information indicating one or more communication resources for use by the UE to request model information corresponding to the model;
receiving the request for the model information from the UE; and
transmitting the model information to the UE.

### (Supplementary Note 4)

The method according to supplementary note 3, wherein the model information comprises at least one of an indication of the identity of the model or a version number of the model.

### (Supplementary Note 5)

The method according to any preceding supplementary note, wherein the method further comprises receiving, from the UE, information indicating a characteristic of the UE; and
determining, based on the characteristic of the UE, at least one of: the model to transmit to the UE, or a configuration for the model to be transmitted to the UE.

### (Supplementary Note 6)

The method according to supplementary note 5, wherein the characteristic of the UE comprises at least one of a capability of the UE, a type of the UE, an indication of a model supported by the UE, or an indication of a configuration for the model supported by the UE.

### (Supplementary Note 7)

The method according to supplementary note 5 or 6, wherein the method further comprises transmitting, to the UE, at least one of: an indication of the model to be transmitted to the UE, an indication of the configuration for the model to be transmitted to the UE, or a size of the model.

### (Supplementary Note 8)

The method according to any one of supplementary notes 5 to 7, wherein the configuration for the model comprises one or more parameters for use with the model to generate the determination, prediction or output parameter.

### (Supplementary Note 9)

The method according to any preceding supplementary note, wherein the method further comprises transmitting the model to the UE using the indicated communication resources.

### (Supplementary Note 10)

The method according to any one of supplementary notes 1 to 8, wherein the indicated communication resources are for use by the UE to receive the model from a node other than the access network node.

### (Supplementary Note 11)

The method according to supplementary note 10, wherein the node other than the access network node is a server that stores the model, or a core network node.

### (Supplementary Note 12)

The method according to supplementary note 10 or 11, wherein the indicated communication resources comprise at least one of a network address of the node other than the access network node, or a configuration for a radio bearer for receiving the model from the node other than the access network node.

### (Supplementary Note 13)

The method according to any preceding supplementary note, wherein the method comprises:
receiving the request for the model in a radio resource control, RRC, transmission; and
transmitting the model to the UE using an RRC transmission.

### (Supplementary Note 14)

The method according to any one of supplementary notes 1 to 12, wherein the model is an AI/ML model, and the method comprises at least one of:
receiving the request for the model using a dedicated protocol layer for transmission of information related to AI/ML models; or
transmitting the model to the UE using the dedicated protocol layer.

### (Supplementary Note 15)

The method according to any one of supplementary notes 1 to 13, wherein the model is an AI/ML model, and the method comprises:
receiving the request for the model in an RRC transmission; and
transmitting the model to the UE using a dedicated protocol layer for transmission of information related to AI/ML models.

### (Supplementary Note 16)

A method performed by an access network node, the method comprising:
receiving, from a user equipment, UE, UE capability information that indicates at least one of:
a feature supported by the UE, wherein the feature is implemented using a corresponding model for generating a determination, prediction or output parameter,
a model for generating a determination, prediction or output parameter that is supported by the UE, or
an indication of one or models stored at the UE;
determining, based on the UE capability information, a model to be transmitted to, or activated at, the UE; and
transmitting, to the UE, at least one of:
model transmission information that includes an indication of one or more communication resources for use by the UE to receive the model;
   the model; or
a request for the UE to activate the model.

### (Supplementary Note 17)

The method according to supplementary note 16, wherein the method further comprises:
determining, based on the UE capability information, to request further UE capability information from the UE;
transmitting, to the UE, a request for the further UE capability information; receiving the further UE capability information from the UE; and
determining the model to be transmitted to the UE based on the further UE capability information.

### (Supplementary Note 18)

The method according to supplementary note 17, wherein the further UE capability information comprises at least one of:
an indication of a version of the model supported by the UE; or
an indication of one or more models that are stored at the UE.

### (Supplementary Note 19)

The method according to any one of supplementary notes 16 to 18, wherein the indicated one or more communication resources are for use by the UE to receive the model from a node other than the access network node.

### (Supplementary Note 20)

The method according to supplementary note 19, wherein the node other than the access network node is a server that stores the model, or a core network node.

### (Supplementary Note 21)

The method according to supplementary note 19 or 20, wherein the indicated communication resources comprise at least one of a network address of the node other than the access network node, or a configuration for a radio bearer for receiving the model from the node other than the access network node.

### (Supplementary Note 22)

The method according to any one of supplementary notes 16 to 21, wherein the method comprises transmitting the request for the UE to activate the model after transmitting the model to the UE.

### (Supplementary Note 23)

The method according to any one of supplementary notes 16 to 21, wherein the method comprises determining that the model is stored at the UE, and transmitting the request for the UE to activate the model stored at the UE.

### (Supplementary Note 24)

A method performed by a user equipment, UE, the method comprising:
receiving, from an access network node, an indication of a feature for implementation in a cell of the access network node, wherein the feature is implemented using a corresponding model for generating a determination, prediction, or output parameter;
determining to obtain the model;
transmitting, to the access network node, a request for the model; and
receiving, from the access network node, at least one of:
model transmission information that includes an indication of one or more communication resources for use by the UE to receive the model; or the model.

### (Supplementary Note 25)

The method according to supplementary note 24, wherein determining to obtain the model comprises determining to obtain the model if the model is not stored at the UE.

### (Supplementary Note 26)

The method according to any one of supplementary note 24 or 25, wherein the method further comprises receiving, from the access network node, information indicating one or more communication resources for use by the UE to request model information corresponding to the model;
transmitting a request for the model information to the access network node; and
receiving the model information from the access network node.

### (Supplementary Note 27)

The method according to supplementary note 26, wherein the model information comprises at least one of an indication of the identity of the model and a version number of the model.

### (Supplementary Note 28)

The method according to any one of supplementary notes 24 to 27, wherein the method further comprises receiving the model from the access network node using the indicated communication resources.

### (Supplementary Note 29)

The method according to any one of supplementary notes 24 to 28, wherein the indicated communication resources are for use by the UE to receive the model from a node other than the access network node; and wherein the method comprises receiving the model from the node other than the access network node.

### (Supplementary Note 30)

The method according to supplementary note 29, wherein the node other than the access network node is a server that stores the model, or a core network node.

### (Supplementary Note 31)

The method according to supplementary note 29 or 30, wherein the indicated communication resources comprise at least one of a network address of the node other than the access network node, or a configuration for a radio bearer for receiving the model from the node other than the access network node.

### (Supplementary Note 32)

The method according to any one of supplementary notes 29 to 31, wherein the method comprises transmitting, based on the indicated communication resources, to the node other than the access network node, a request for the model.

### (Supplementary Note 33)

A method performed by a user equipment, UE, the method comprising:
transmitting, to an access network node, UE capability information that indicates at least one of:
a feature supported by the UE, wherein the feature is implemented using a corresponding model for generating a determination, prediction or output parameter,
a model for generating a determination, prediction or output parameter that is supported by the UE, or
an indication of one or models stored at the UE; and
receiving, from the access network node, at least one of:
model transmission information that includes an indication of one or more communication resources for use by the UE to receive the model;
   the model; or
a request for the UE to activate the model.

### (Supplementary Note 34)

The method according to supplementary note 33, wherein in a case where the UE receives the request for the UE to activate the model, the UE activates the model.

### (Supplementary Note 35)

The method according to supplementary note 33 or 34, wherein the method further comprises:
receiving, from the access network node, a request for further UE capability information; and
transmitting the further UE capability information to the access network node.

### (Supplementary Note 36)

The method according to supplementary note 35, wherein the further UE capability information comprises at least one of:
an indication of a version of the model supported by the UE; or
an indication of one or more models that are stored at the UE.

### (Supplementary Note 37)

The method according to any one of supplementary notes 33 to 36, wherein the indicated one or more communication resources are for use by the UE to receive the model from a node other than the access network node.

### (Supplementary Note 38)

The method according to supplementary note 37, wherein the node other than the access network node is a server that stores the model, or a core network node.

### (Supplementary Note 39)

The method according to supplementary note 37 or 38, wherein the indicated communication resources comprise at least one of a network address of the node other than the access network node, or a configuration for a radio bearer for receiving the model from the node other than the access network node.

### (Supplementary Note 40)

The method according to any one of supplementary notes 33 to 39, wherein in a case where the UE receives the model from the access network node, the method further comprises transmitting, to the access network node, an indication of whether the model has been received at the UE.

### (Supplementary Note 41)

A method performed by a user equipment, UE, the method comprising:
in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE:
maintaining the portion of the model in a memory of the UE;
re-establishing a radio link between the UE and the access network node, or establishing a radio link between the UE and another access network node;
in a case where the radio link is re-established between the UE and the access network node:
transmitting, to the access network node, an indication of the portion of the model that is stored at the UE; and
receiving, from the access network node, the remaining portion of the model; and
in a case where the radio link is established with the another access network node:
transmitting, to the another access network node, the indication of the portion of the model that is stored at the UE; and
receiving, from the another access network node, the remaining portion of the model.

### (Supplementary Note 42)

The method according to supplementary note 41, wherein the portion of the model was received at the UE in plurality of data transfer units, each data transfer unit comprising a sub-portion the model; and
wherein the indication of the portion of the model that is stored at the UE comprises an indication of an identity of the last data transfer unit received at the UE.

### (Supplementary Note 43)

The method according to supplementary note 42, wherein the indication of an identity of the last data transfer unit received at the UE comprises an indication of an identity of a radio resource control, RRC, segment, or an indication of an identity of a packet data convergence protocol, PDCP, sequence number, SN.

### (Supplementary Note 44)

The method according to any one of supplementary notes 41 to 43 wherein in the case where the radio link is established with the another access network, the method further comprises:
transmitting to the another access network node, at least one of:
an indication of an identity of the model; or
and indication of the identity of the access network node from which the UE received the portion of the model.

### (Supplementary Note 45)

The method according to any one of supplementary notes 41 to 43 wherein in the case where the radio link is re-established with the access network node, the method further comprises transmitting, to the access network node, and indication of the identity of the model.

### (Supplementary Note 46)

A method performed by a user equipment, UE, the method comprising:
receiving, from a first access network node, a portion of a model for generating a determination, prediction, or output parameter;
performing a handover procedure for handover of the UE from the first access network node to a second access network node;
maintaining the portion of the model in a memory of the UE 3 during the handover procedure;
transmitting, to the second access network node, an indication of the portion of the model that is stored at the UE; and
receiving, from the another access network node, the remaining portion of the model.

### (Supplementary Note 47)

The method according to supplementary note 46, wherein the method further comprises receiving, from the first access network node or the second access network node, an indication that the UE is to receive the remaining portion of the model from the second access network node.

### (Supplementary Note 48)

The method according to supplementary note 46 or 47, wherein the portion of the model was received at the UE from the first access network node in plurality of data transfer units, each data transfer unit comprising a sub-portion the model; and
wherein the indication of the portion of the model that is stored at the UE comprises an indication of an identity of the last data transfer unit received at the UE.

### (Supplementary Note 49)

The method according to supplementary note 48, wherein the indication of an identity of the last data transfer unit received at the UE comprises an indication of an identity of a radio resource control, RRC, segment, or an indication of an identity of a packet data convergence protocol, PDCP, sequence number, SN.

### (Supplementary Note 50)

A method performed by an access network node, the method comprising:
in a case where the access network node has transmitted, to a user equipment, UE, using a radio link between the UE and the access network node, a portion of a model for generating a determination, prediction, or output parameter, and a failure of the radio link has occurred after the portion of a model has been transmitted to the UE but before a remaining portion of the model has been transmitted to the UE:
re-establishing a radio link between the UE and the access network node; receiving, from the UE, an indication of a portion of the model that is stored at the UE;
determining, based on the indication of a portion of the model that is stored at the UE, the remaining portion of the model to be transmitted to the UE; and transmitting, to the UE, the remaining portion of the model.

### (Supplementary Note 51)

The method according to supplementary note 50, wherein the portion of the model was transmitted to the UE in plurality of data transfer units, each data transfer unit comprising a sub-portion the model; and
wherein the indication of the portion of the model that is stored at the UE comprises an indication of an identity of the last data transfer unit received at the UE.

### (Supplementary Note 52)

The method according to supplementary note 51, wherein the indication of an identity of the last data transfer unit received at the UE comprises an indication of an identity of a radio resource control, RRC, segment, or an indication of an identity of a packet data convergence protocol, PDCP, sequence number, SN.

### (Supplementary Note 53)

The method according to any one of supplementary notes 50 to 52, wherein the UE is in a radio resource control, RRC, connected state when the access network node transmits the portion of the model to the UE; and
wherein the access network node maintains a context associated with the RRC connected state after the failure of the radio link has occurred.

### (Supplementary Note 54)

A method performed by a first access network node, the method comprising:
transmitting, to a user equipment, UE, a portion of a model for generating a determination, prediction, or output parameter;
transmitting, to the UE, an indication that a remaining portion of the model is to be received from a second access network node; and
performing a handover procedure for handover of the UE from the first access network node to the second access network node.

### (Supplementary Note 55)

The method according to supplementary note 54, wherein the method further comprises transmitting, to the second access network node, the remaining portion of the model, for transmission of the remaining portion of the model from the second access network node to the UE.

### (Supplementary Note 56)

The method according to supplementary note 54 or 55, wherein the method further comprises transmitting, to the second access network node, an indication of the identity of the model.

### (Supplementary Note 57)

A method performed by a second access network node, the method comprising:
performing a handover procedure for handover of a UE from a first access network node to the second access network node;
receiving, from the UE or from the first access network node, an indication of a portion of a model for generating a determination, prediction, or output parameter that is stored at the UE, or an indication of a remaining portion of the model to be transmitted to the UE; and
transmitting, to the UE, the remaining portion of the model.

### (Supplementary Note 58)

The method according to supplementary note 57, wherein the method further comprises receiving, from the first access network node, the remaining portion of the model.

### (Supplementary Note 59)

The method according to supplementary note 57 or 58, wherein the method further comprises receiving, from the first access network node, an indication of the identity of the model.

### (Supplementary Note 60)

A method performed by a user equipment, UE, the method comprising:
receiving a model for generating a determination, prediction, or output parameter;
determining to activate the model for use at the UE;
activating the model for use at the UE;
determining to transmit, to an access network node, an indication that the model has been activated for use at the UE; and
transmitting, to the access network node, the indication that the model has been activated for use at the UE.

### (Supplementary Note 61)

The method according to supplementary note 60, wherein the determining to transmit the indication that the model has been activated for use at the UE comprises determining to transmit the indication to the access network node when the model was received in a broadcast transmission.

### (Supplementary Note 62)

A method performed by a user equipment, UE, the method comprising:
receiving a model for generating a determination, prediction, or output parameter;
receiving, from an access network node, an indication that the model is to be activated for use at the UE;
determining, based on the indication, to activate the model for use at the UE; and
activating the model for use at the UE.

### (Supplementary Note 63)

The method according to supplementary note 62, wherein the model is an artificial intelligence or machine learning, AI/ML, model.

### (Supplementary Note 64)

A method of a user equipment, UE, the method comprising:
receiving, from an access network node, an indication of a model for generating a determination, prediction, or output parameter that is supported for use in a cell of the access network node; and
transmitting, to the access network node, an indication of whether the UE is able to receive and use the model.

### (Supplementary Note 65)

The method according to supplementary note 64, wherein the method further comprises receiving, from the access network node, a request for the indication of whether the UE is able to receive and use the model; and transmitting the indication of whether the UE is able to receive and use the model to the access network node after receiving the request.

### (Supplementary Note 66)

The method according to any one of supplementary note 64 to 65, wherein the indication of whether the UE is able to receive and use the model comprises an indication of at least one of a state of a memory resource at the UE, a state of a processing resource at the UE, or a state of a power resource at the UE.

### (Supplementary Note 67)

A method of an access network node, the method comprising:
transmitting, to a user equipment, UE, an indication of a model for generating a determination, prediction, or output parameter that is supported for use in a cell of the access network node;
receiving, from the UE, an indication of whether the UE is able to receive or use the model; and
determining whether the model is to be transmitted to the UE, or activated for use at the UE, based on the received indication.

### (Supplementary Note 68)

The method according to supplementary note 67, wherein the indication of whether the UE is able to receive and use the model comprises an indication of at least one of a state of a memory resource at the UE, a state of a processing resource at the UE, or a state of a power resource at the UE.

### (Supplementary Note 69)

An access network node comprising:
means for transmitting, to a user equipment, UE, an indication of a feature for implementation in a cell of the access network node, wherein the feature is implemented using a corresponding model for generating a determination, prediction, or output parameter;
means for receiving, from the UE, a request for the model; and
wherein the means for transmitting is configured for transmitting, to the UE, at least one of:
model transmission information that includes an indication of one or more communication resources for use by the UE to receive the model; or the model.

### (Supplementary Note 70)

An access network node comprising:
means for receiving, from a user equipment, UE, UE capability information that indicates at least one of:
a feature supported by the UE, wherein the feature is implemented using a corresponding model for generating a determination, prediction or output parameter,
a model for generating a determination, prediction or output parameter that is supported by the UE, or
an indication of one or models stored at the UE;
means for determining, based on the UE capability information, a model to be transmitted to, or activated at, the UE; and
means for transmitting, to the UE, at least one of:
model transmission information that includes an indication of one or more communication resources for use by the UE to receive the model;
   the model; or
a request for the UE to activate the model.

### (Supplementary Note 71)

A user equipment, UE, comprising:
means for receiving, from an access network node, an indication of a feature for implementation in a cell of the access network node, wherein the feature is implemented using a corresponding model for generating a determination, prediction, or output parameter;
means for determining to obtain the model;
means for transmitting, to the access network node, a request for the model; and
where in the means for receiving is configured for receiving, from the access network node, at least one of:
model transmission information that includes an indication of one or more communication resources for use by the UE to receive the model; or the model.

### (Supplementary Note 72)

A user equipment, UE, comprising:
means for transmitting, to an access network node, UE capability information that indicates at least one of:
a feature supported by the UE, wherein the feature is implemented using a corresponding model for generating a determination, prediction or output parameter,
a model for generating a determination, prediction or output parameter that is supported by the UE, or
an indication of one or models stored at the UE; and
means for receiving, from the access network node, at least one of:
model transmission information that includes an indication of one or more communication resources for use by the UE to receive the model;
   the model; or
a request for the UE to activate the model.

### (Supplementary Note 73)

A user equipment, UE, configured for, in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE:
discarding the portion of the model;
   transmitting, when a radio link between the UE and the access network node is re-established, a request for the model; and
receiving the model from the access network node.

### (Supplementary Note 74)

A user equipment, UE, configured for, in a case where the UE has received, from an access network node, using a radio link between the UE and the access network node, a portion of a model for generating a determination, prediction, or output parameter, and a failure of the radio link has occurred after the portion of a model has been received from the access network node but before a remaining portion of the model has been received by the UE:
maintaining the portion of the model in a memory of the UE 3;
re-establishing a radio link between the UE and the access network node, or establishing a radio link between the UE and another access network node;
in a case where the radio link is re-established between the UE and the access network node:
transmitting, to the access network node, an indication of the portion of the model that is stored at the UE; and
receiving, from the access network node, the remaining portion of the model; and
in a case where the radio link is established with the another access network node:
transmitting, to the another access network node, the indication of the portion of the model that is stored at the UE; and
receiving, from the another access network node, the remaining portion of the model.

### (Supplementary Note 75)

A user equipment, UE, comprising:
means for receiving, from a first access network node, a portion of a model for generating a determination, prediction, or output parameter;
means for performing a handover procedure for handover of the UE from the first access network node to a second access network node;
means for maintaining the portion of the model in a memory of the UE 3 during the handover procedure;
means for transmitting, to the second access network node, an indication of the portion of the model that is stored at the UE; and
means for receiving, from the another access network node, the remaining portion of the model.

### (Supplementary Note 76)

An access network node configured for, in a case where the access network node has transmitted, to a user equipment, UE, using a radio link between the UE and the access network node, a portion of a model for generating a determination, prediction, or output parameter, and a failure of the radio link has occurred after the portion of a model has been transmitted to the UE but before a remaining portion of the model has been transmitted to the UE:
re-establishing a radio link between the UE and the access network node; receiving, from the UE, an indication of a portion of the model that is stored at the UE;
determining, based on the indication of a portion of the model that is stored at the UE, the remaining portion of the model to be transmitted to the UE; and
transmitting, to the UE, the remaining portion of the model.

### (Supplementary Note 77)

A first access network node comprising:
means for transmitting configured for:
transmitting, to a user equipment, UE, a portion of a model for generating a determination, prediction, or output parameter, and
transmitting, to the UE, an indication that a remaining portion of the model is to be received from a second access network node; and
means for performing a handover procedure for handover of the UE from the first access network node to the second access network node.

### (Supplementary Note 78)

A second access network node comprising:
means for performing a handover procedure for handover of a UE from a first access network node to the second access network node;
means for receiving, from the UE or from the first access network node, an indication of a portion of a model for generating a determination, prediction, or output parameter that is stored at the UE, or an indication of a remaining portion of the model to be transmitted to the UE; and
means for transmitting, to the UE, the remaining portion of the model.

### (Supplementary Note 79)

A user equipment, UE, comprising:
means for receiving a model for generating a determination, prediction, or output parameter;
means for determining to activate the model for use at the UE;
means for activating the model for use at the UE;
means for determining to transmit, to an access network node, an indication that the model has been activated for use at the UE; and
means for transmitting, to the access network node, the indication that the model has been activated for use at the UE.

### (Supplementary Note 80)

A user equipment, UE, comprising:
means for receiving configured for:
receiving a model for generating a determination, prediction, or output parameter; and
receiving, from an access network node, an indication that the model is to be activated for use at the UE;
means for determining, based on the indication, to activate the model for use at the UE; and
means for activating the model for use at the UE.

### (Supplementary Note 81)

A user equipment, UE, comprising:
means for receiving, from an access network node, an indication of a model for generating a determination, prediction, or output parameter that is supported for use in a cell of the access network node; and
means for transmitting, to the access network node, an indication of whether the UE is able to receive and use the model.

### (Supplementary Note 82)

An access network node comprising:
means for transmitting, to a user equipment, UE, an indication of a model for generating a determination, prediction, or output parameter that is supported for use in a cell of the access network node;
means for receiving, from the UE, an indication of whether the UE is able to receive or use the model; and
means for determining whether the model is to be transmitted to the UE, or activated for use at the UE, based on the received indication.

This application is based upon and claims the benefit of priority from Great Britain Patent Application No. 2302236.1, filed on Feb. 16, 2023, the disclosure of which is incorporated herein in its entirety by reference.

### REFERENCE SIGNS LIST

3 User Equipment
5 (Radio) Access Network ((R)AN) node, Base Station, gNB
5-1 First Base Station
5-2 Second Base Station
7 Core Network
9 Cell
10 Control Plane Functions (CPF)
10-1 Access Management Function
10-2 Session Management Function
10-n Other Functions
11 User Plane Function (UPF)
41 Data Collection Function
43 Model Training Function
45 Model Inference Function
47 Actor
50 Distributed Unit (DU)
60 Central Unit (CU)
151 AI/ML Server
310 TRANSCEIVER CIRCUIT
330 ANTENNA(S)
350 USER INTERFACE
390 MEMORY
410 OPERATING SYSTEM
430 COMMUNICATIONS CONTROL MODULE
450 AI/ML MODULE
451 TRANSCEIVER CIRCUIT
453 RU INTERFACE
454 CU INTERFACE
457 CONTROLLER
459 MEMORY
461 OPERATING SYSTEM
463 COMMUNICATIONS CONTROL MODULE
465 F1 MODULE
468 DU-RU MODULE
472 DU MANAGEMENT MODULE
473 UE PROFILE MANAGEMENT MODULE
475 MOBILITY MODULE
510 TRANSCEIVER CIRCUIT
530 ANTENNA
550 CORE NETWORK INTERFACE(s)
551 TRANSCEIVER CIRCUIT
554 DU INTERFACES
555 CU INTERFACES
557 CONTROLLER
559 MEMORY
561 OPERATING SYSTEM
563 COMMUNICATIONS CONTROL MODULE
565 F1 MODULE
566 E1 MODULE
568 N2 MODULE
569 N3 MODULE
570 CONTROLLER
571 CU-UP MANAGEMENT MODULE
572 CU-CP MANAGEMENT MODULE
573 UE PROFILE MANAGEMENT MODULE
575 MOBILITY MODULE
590 MEMORY
610 OPERATING SYSTEM
630 COMMUNICATIONS CONTROL MODULE
650 AI/ML MODULE
710 TRANSCEIVER CIRCUIT
720 NETWORK INTERFACE(s)
730 CONTROLLER
740 MEMORY
750 OPERATING SYSTEM
760 COMMUNICATIONS CONTROL MODULE
770 AI/ML MODULE

What is claimed is:

1-26. (canceled)

27. A method performed by a mobile device, the method comprising:
transmitting, to an access network node, user equipment (UE) capability information indicating at least one of:
at least one usage of at least one supported artificial intelligence/machine learning (AI/ML) model which the mobile device supports, or
at least one supported AI/ML model which the mobile device supports;
receiving, from the access network node, a request message for transmitting UE capability related to at least one requested AI/ML model from the at least one supported AI/ML model;
transmitting, to the access network node, detail information indicating the UE capability related to one or more of the at least one requested AI/ML model;
receiving, from the access network node, information for indicating an operation condition related to at least one AI/ML model from the one of more of the at least one requested AI/ML; model;
applying the operation condition related to at least one applicable AI/ML model from at least one AI/ML model from the one of more of the at least one requested AI/ML model based on the information;
receiving, from the access network node, at least one of:
identity information of at least one specific AI/ML model from the at least one applicable AI/ML model, and
a size of the at least one AI/ML specific model; and
determining whether the mobile device should initiate a procedure for the mobile device to receive the at least one specific AI/ML model.

28. The method according to claim 27, wherein
the operation condition indicates at least one of:
information indicating a version of the at least one applicable AI/ML model to be run by the mobile device,
information indicating a usage of the at least one applicable AI/ML model to be run by the mobile device,
information indicating that an explicit activation by the access network node is needed.

29. The method according to claim 27, further comprising:
transmitting, to the access network node, information indicating at least one activated AI/ML model which the mobile device is running.

30. The method according to claim 29, wherein
the transmitting is performed upon a request from the access network node.

31. The method according to claim 27, wherein
the operation condition indicates at least one of:
whether the mobile device should run one or more of the at least one applicable AI/ML model or not,
whether the mobile device should activate one or more of the at least one applicable AI/ML model or not, or
whether the mobile device should receive, from the access network node, one or more of the at least one applicable AI/ML model or not.

32. The method according to claim 27, wherein
the operation condition includes status information of the UE-mobile device for determining at least one of:
whether the mobile device is allowed to run one or more of the at least one applicable AI/ML model or not,
whether the mobile device is allowed to activate one or more of the at least one applicable AI/ML model or not, or
whether the mobile device is allowed to receive one or more of the at least one applicable AI/ML model or not.

33. The method according to claim 27, further comprising:
in a case where the mobile device should initiate a procedure for the UE-mobile device to receive the at least one specific AI/ML model:
transmitting, to the access network node, a message for initiating the procedure for the UE to receive the at least one specific AI/ML model; and
receiving, from the access network node, the at least one specific AI/ML model.

34. The method according to claim 33, wherein
the receiving the at least one specific AI/ML model is performed using at least one of:
a Radio Resource Control (RRC) layer,
a new layer used for AI/ML model transfer,
an application layer,
at least one layer lower than the RRC layer, or
a data radio bearer between the mobile device and the access network node.

35. The method according to claim 33, wherein
the receiving the at least one specific AI/ML model is performed:
after receiving, from the access network node, at least one signaling including assistance information for the receiving the at least one specific AI/ML model, and
using the assistance information.

36. The method according to claim 35, wherein
the assistance information indicating at least one of:
resource configuration to be used by mobile device to receive the at least one specific AI/ML model,
radio bearer configuration to be used by mobile device to receive the at least one specific AI/ML model, or
scheduling to receive the at least one specific AI/ML model.

37. The method according to claim 33, wherein
the receiving the at least one specific AI/ML model is performed by at least one of:
at least one dedicated transmission,
at least one multicast transmission, or
at least one broadcast transmission.

38. The method according to claim 33, further comprising:
transmitting a status of the receiving the at least one specific AI/ML model, wherein
the status of the receiving the at least one specific AI/ML model indicates at least one of:
whether the receiving the at least one specific AI/ML model is successfully completed, or
whether retransmission of the at least one specific AI/ML model is required.

39. The method according to claim 33, wherein
the message is forwarded, by the access network node, to at least one of:
an external entity,
a core network node, or
a service management orchestration server, and
the at least one specific AI/ML model is transmitted from the at least one of:
the external entity,
the core network node, or
the service management orchestration server,
via the access network node.

40. The method according to claim 33, further comprising
in a case where the receiving the at least one specific AI/ML model is interrupted:
discarding at least one segment of the at least one specific AI/ML model which the mobile device has received; and
restarting the receiving the at least one specific AI/ML model.

41. The method according to claim 33, further comprising:
in a case where the receiving the at least one specific AI/ML model is interrupted:
resuming the receiving the at least one specific AI/ML model on:
a same cell as before the receiving the at least one specific AI/ML model is interrupted, or
a different cell.

42. The method according to claim 41, wherein
information indicating at least one segment of the at least one specific AI/ML model which the mobile device has received, is:
stored in a context of the mobile device,
transmitted to the access network node,
transmitted to a further access network node which operates a cell used for the resuming the receiving the at least one specific AI/ML model.

43. The method according to claim 42, wherein
the further access network node is different from the access network node,
the information indicating the at least one segment of the at least one specific AI/ML model which the mobile device has received is transmitted from the mobile device to the access network node,
handover related information is transmitted from the access network node to the further access network node, and
the handover related information includes at least one of:
information identifying the at least one specific AI/ML model,
information indicating the at least one segment of the at least one specific AI/ML model which the access network node has transmitted, or
at least one remaining segment of the at least one specific AI/ML model.

44. A method performed by an access network node, the method comprising:
receiving, from a mobile device, user equipment (UE) capability information indicating at least one of:
at least one usage of at least one supported artificial intelligence/machine learning (AI/ML) model which the mobile device supports, or
at least one supported AI/ML model which the mobile device supports;
transmitting, to the mobile device, a request message for transmitting UE capability related to at least one requested AI/ML model from the at least one supported AI/ML model;
receiving, from the mobile device, detail information indicating the UE capability related to one or more of the at least one requested AI/ML model;
transmitting, to the mobile device, information for indicating an operation condition related to at least one AI/ML model from the one of more of the at least one requested AI/ML model for use by the mobile device in applying the operation condition related to the at least one applicable AI/ML model from at least one AI/ML model from the one of more of the at least one requested AI/ML model;
transmitting, to the mobile device, at least one of:
identity information of at least one specific AI/ML model from the at least one applicable AI/ML model, and
a size of the at least one AI/ML specific model,
for use by the mobile device in determining whether the mobile device should initiate a procedure for the mobile device to receive the at least one specific AI/ML model.

45. A mobile device comprising:
at least one memory storing instructions, and
at least one processor configured to process the instructions to;
transmit, to an access network node, user equipment (UE) capability information indicating at least one of:
at least one usage of at least one supported artificial intelligence/machine learning (AI/ML) model which the mobile device supports, or
at least one supported AI/ML model which the mobile device supports;
receive, from the access network node, a request message for transmitting UE capability related to at least one requested AI/ML model from the at least one supported AI/ML model;
transmit, to the access network node, detail information indicating the UE capability related to one or more of the at least one requested AI/ML model;
receive, from the access network node, information for indicating an operation condition related to at least one AI/ML model from the one of more of the at least one requested AI/ML model;
apply the operation condition related to at least one applicable AI/ML model from at least one AI/ML model from the one of more of the at least one requested AI/ML model based on the information;
receive, from the access network node, at least one of:
identity information of at least one specific AI/ML model from the at least one applicable AI/ML model, and
a size of the at least one AI/ML specific model; and
determine whether the mobile device should initiate a procedure for the mobile device to receive the at least one specific AI/ML model.

46. An access network node comprising:
at least one memory storing instructions, and
at least one processor configured to process the instructions to;
receive, from a mobile device, user equipment (UE) capability information indicating at least one of:
at least one usage of at least one supported artificial intelligence/machine learning (AI/ML) model which the mobile device supports, or
at least one supported AI/ML model which the mobile device supports;
transmit, to the mobile device, a request message for transmitting UE capability related to at least one requested AI/ML model from the at least one supported AI/ML model;
receive, from the mobile device, detail information indicating the UE capability related to one or more of the at least one requested AI/ML model;
transmit, to the mobile device, information for indicating an operation condition related to at least one AI/ML model from the one of more of the at least one requested AI/ML; model for use by the mobile device in applying the operation condition related to the at least one applicable AI/ML model from at least one AI/ML model from the one of more of the at least one requested AI/ML model;
transmit, to the mobile device, at least one of:
identity information of at least one specific AI/ML model from the at least one applicable AI/ML model, and
a size of the at least one AI/ML specific model,
for use by the mobile device in determining whether the mobile device should initiate a procedure for the mobile device to receive the at least one specific AI/ML model.
